(19) United States
(12) Patent Application Publication
(10) Pub. No.: US 2024/0209258 A1
(43) Pub. Date: Jun. 27, 2024

(54) METHOD FOR PRODUCING SEMICONDUCTOR NANOPARTICLES

(71) Applicants: NATIONAL UNIVERSITY CORPORATION TOKAI NATIONAL HIGHER EDUCATION AND RESEARCH SYSTEM, Nagoya-shi (JP); OSAKA UNIVERSITY, Suita-shi (JP); NICHIA CORPORATION, Anan-shi (JP)

(72) Inventors: Tsukasa TORIMOTO, Nagoya-shi (JP); Tatsuya KAMEYAMA, Nagoya-shi (JP); Susumu KUWABATA, Suita-shi (JP); Taro UEMATSU, Suita-shi (JP); Yohei IKAGAWA, Naruto-shi (JP); Daisuke OYAMATSU, Tokushima-shi (JP); Tomoya KUBO, Tokushima-shi (JP)

(73) Assignees: NATIONAL UNIVERSITY CORPORATION TOKAI NATIONAL HIGHER EDUCATION AND RESEARCH SYSTEM, Nagoya-shi (JP); OSAKA UNIVERSITY, Suita-shi (JP); NICHIA CORPORATION, Anan-shi (JP)

(21) Appl. No.: 18/554,068

(22) PCT Filed: Feb. 22, 2022
(86) PCT No.: PCT/JP2022/007308

§ 371 Date: Oct. 5, 2023

(30) Foreign Application Priority Data
Apr. 9, 2021 (JP) 2021-066682

(51) Int. Cl. C09K 11/62; B82Y 20/00; B82Y 40/00

(52) U.S. Cl. CPC C09K 11/626; B82Y 20/00; B82Y 40/00

(57) ABSTRACT

Provided is a method of producing semiconductor nanoparticles that exhibit band-edge emission and have excellent band-edge emission purity and internal quantum yield. The method includes: providing first semiconductor nanoparticles that contains a semiconductor containing an element M¹, an element M², and an element Z, where the element M¹ is at least one element selected from the group consisting of Ag, Cu, Au, and alkali metals, and contains at least Ag, the element M² is at least one element selected from the group consisting of Al, Ga, In, and Tl, and contains at least one of In or Ga, and the element Z contains at least one element selected from the group consisting of S, Se, and Te; heat-treating a mixture, which contains the first semiconductor nanoparticles, a compound containing a Group 13 element, and a compound containing a Group 16 element, to obtain second semiconductor nanoparticles; and heat-treating the second semiconductor nanoparticles in the presence of a halide of a Group 13 element to obtain third semiconductor nanoparticles.

### TECHNICAL FIELD

The present disclosure relates to a method of producing semiconductor nanoparticles.

### BACKGROUND ART

Semiconductor particles having a particle size of, for example, 10 nm or smaller are known to exhibit a quantum size effect, and such nanoparticles are referred to as “quantum dots” (also referred to as “semiconductor quantum dots”). The “quantum size effect” refers to a phenomenon in which a valence band and a conduction band that are each regarded as continuous in bulk particles become discrete when the particle size is on the nanoscale and the band-gap energy varies with the particle size.

Quantum dots are capable of absorbing light and converting the wavelength into a light corresponding to their band-gap energy; therefore, white light emitting devices utilizing emission of such quantum dots have been proposed (see, for example, Japanese Laid-Open Patent Publication Nos. 2012-212862 and 2010-177656). In addition, wavelength conversion films containing core-shell-structured semiconductor quantum dots that can exhibit band-edge emission and have a low-toxicity composition have been proposed (see, for example, WO 2014/129067). Further, sulfide nanoparticles have been studied as ternary semiconductor nanoparticles that can exhibit band-edge emission and have a low-toxicity composition, (see, for example, WO 2018/159699 and WO 2019/160094).

### SUMMARY OF INVENTION

### Technical Problem

An object of an embodiment of the present disclosure is to provide a method of producing semiconductor nanoparticles that exhibit band-edge emission and have excellent band-edge emission purity and excellent internal quantum yield.

### Solution to Problem

A first embodiment is a method of producing semiconductor nanoparticles, the method including: providing first semiconductor nanoparticles that contain a semiconductor containing an element M¹, an element M², and an element Z, and in which the element M¹ is at least one element selected from the group consisting of Ag, Cu, Au, and alkali metals, and contains at least Ag, the element M² is at least one element selected from the group consisting of Al, Ga, In, and Tl, and contains at least one of In or Ga, and the element Z contains at least one element selected from the group consisting of S, Se, and Te;
performing a heat treatment of a mixture comprising the first semiconductor nanoparticles, a compound containing a Group 13 element, and a compound containing a Group 16 element, to obtain second semiconductor nanoparticles; and
performing a heat treatment of the second semiconductor nanoparticles in the presence of a halide of a Group 13 element to obtain third semiconductor nanoparticles.

### Advantageous Effects of Invention

According to an embodiment of the present disclosure, a method of producing semiconductor nanoparticles that exhibit band-edge emission and have excellent band-edge emission purity and excellent internal quantum yield may be provided.

### BRIEF DESCRIPTION OF DRAWINGS

FIG. 1 shows examples of emission spectrum for the semiconductor nanoparticles of Example 1, Reference Example 1, and Comparative Example 1.

FIG. 2 shows examples of emission spectrum for the semiconductor nanoparticles of Comparative Examples 2 to 4.

FIG. 3 shows examples of emission spectrum for the first, second, and third semiconductor nanoparticles of Example 2.

FIG. 4 shows an example of emission spectrum for the first semiconductor nanoparticles of Comparative Example 5.

### DESCRIPTION OF EMBODIMENTS

The term “step” used herein encompasses not only a discrete step but also a step that cannot be clearly distinguished from other steps, as long as the intended purpose of the step is achieved. When there are plural substances that correspond to a component of a composition, an indicated amount of the component contained in the composition means, unless otherwise specified, a total amount of the plural substances existing in the composition. Further, as an upper limit and a lower limit of a numerical range described in the present specification, the values exemplified for the numerical range can be arbitrarily selected and combined. Embodiments of the present invention will now be described in detail. It is noted here, however, that the below-described embodiments are merely examples of a method of producing semiconductor nanoparticles that embody the technical idea of the present invention, and the present invention is not limited to the below-described method of producing semiconductor nanoparticles.

### Method of Producing Semiconductor Nanoparticles

The method of producing semiconductor nanoparticles may include: a first step of providing first semiconductor nanoparticles that contain a semiconductor containing an element M¹, an element M², and an element Z; a second step of performing a heat treatment of a mixture, which contains the first semiconductor nanoparticles, a compound containing a Group 13 element, and a compound containing a Group 16 element, to obtain second semiconductor nanoparticles; and a third step of performing a heat treatment of the second semiconductor nanoparticles in the presence of a halide of a Group 13 element to obtain third semiconductor nanoparticles. The element M¹ is at least one element selected from the group consisting of Ag, Cu, Au, and alkali metals, and may contain at least Ag. The element M² is at least one element selected from the group consisting of Al, Ga, In, and Tl, and may contain at least one of In or Ga. The element Z is at least one element selected from the group consisting of S, Se, and Te.

By performing a heat treatment of a mixture that contains the first semiconductor nanoparticles, a compound containing a Group 13 element, and a compound containing a Group 16 element, second semiconductor nanoparticles in which a semiconductor containing the Group 13 element and the Group 16 element (e.g., GaSₓ in a case where the Group 13 element is gallium (Ga) and the Group 16 element is sulfur (S); x is, for example, from 0.8 to 1.5) is arranged on the surfaces of the first semiconductor nanoparticles are obtained. Subsequently, by performing a heat treatment of the second semiconductor nanoparticles in the presence of a halide of a Group 13 element, third semiconductor nanoparticles are obtained. In the third semiconductor nanoparticles, the Group 13 element moiety of the halide of the Group 13 element reacts with defects of the Group 13 element (e.g., gallium-deficient parts) of the semiconductor containing the Group 13 element and the Group 16 element in the second semiconductor nanoparticles, whereby the defects of the Group 13 element are filled. In addition, a reaction of the Group 16 element component existing in the reaction system leads to an increase in the concentration of the Group 13 element and the Group 16 element in the vicinity of the defects of the Group 13 element, and the defects of the Group 13 element are thereby compensated. It may be thought that, as a result, the band-edge emission purity and the internal quantum yield of the third semiconductor nanoparticles are improved. It may also be thought that, in the third semiconductor nanoparticles, the Group 13 element of the halide of the Group 13 element is coordinated to the Group 16 element atoms of the semiconductor of the second semiconductor nanoparticles that contains the Group 13 element and the Group 16 element, and the halogen atom of the thus coordinated halide of the Group 13 element reacts with the Group 16 element component existing in the reaction system, whereby the concentration of the Group 13 element and the Group 16 element in the vicinity of the surface is increased and the remaining surface defects are reduced, as a result of which the band-edge emission purity and the internal quantum yield are improved.

### First Step

The first step may include the step of providing first semiconductor nanoparticles that contain a semiconductor containing an element M¹, an element M², and an element Z. As the first semiconductor nanoparticles, for example, those semiconductor nanoparticles obtained by the any of the methods described in WO 2018/159699, WO 2019/160094, and WO 2020/162622 may be used. Besides these methods, first semiconductor nanoparticles produced by, for example, the following method may be used as well, and the method of producing the first semiconductor nanoparticles may include: the mixing step (hereinafter, also referred to as “first mixing step”) of obtaining a mixture that contains an element M¹-containing salt, an element M²-containing salt, a compound containing the element M² and the element Z, and an organic solvent (this mixture is hereinafter also referred to as “first mixture”); and the heat treatment step (hereinafter, also referred to as “first heat treatment step”) of performing a heat treatment of the first mixture (hereinafter, also referred to as “first heat treatment”) to obtain the first semiconductor nanoparticles.

In the first mixing step, a first mixture may be prepared by mixing an element M¹-containing salt, an element M²-containing salt, a compound containing the element M² and the element Z, and an organic solvent. A mixing method in the first mixing step may be selected as appropriate from those mixing methods that are normally employed.

The element M¹-containing salt and the element M²-containing salt in the first mixture may each be either an organic acid salt or an inorganic acid salt. Specifically, examples of the inorganic acid salt include nitrates, sulfates, hydrochlorides, and sulfonates, and examples of the organic acid salt include formates, acetates, oxalates, and acetylacetonates. The element M¹-containing salt and the element M²-containing salt may each be preferably at least one selected from the group consisting of these acid salts, and the element M¹-containing salt and the element M²-containing salt may each be more preferably at least one selected from the group consisting of organic acid salts such as acetates and acetylacetonates because these salts are highly soluble in organic solvents and thus allow reaction to proceed more uniformly. The first mixture may contain each of the element M¹-containing salt and the element M²-containing salt singly, or in combination of two or more of each of these salts.

The element M¹-containing salt in the first mixture may be a compound containing the element M¹ and the element Z, or a compound having an M¹-Z bond. The M¹-Z bond may be any of a covalent bond, an ionic bond, a coordinate bond, and the like. Examples of the compound containing the element M¹ and the element Z include element M¹-containing salts of sulfur-containing compounds, and the compound containing the element M¹ and the element Z may be an organic acid salt, inorganic acid salt, organic metal compound, or the like of the element M¹. Examples of the sulfur-containing compounds include thiocarbamic acids, dithiocarbamic acids, thiocarbonic acids, dithiocarbonic acids (xanthic acid), trithiocarbonic acids, thiocarboxylic acids, dithiocarboxylic acids, and derivatives thereof. Thereamong, at least one selected from the group consisting of xanthic acid and derivatives thereof is preferred because these compounds are decomposed at a relatively low temperature. Specific examples of the sulfur-containing compounds include aliphatic thiocarbamic acids, aliphatic dithiocarbamic acids, aliphatic thiocarbonic acids, aliphatic dithiocarbonic acids, aliphatic trithiocarbonic acids, aliphatic thiocarboxylic acids, and aliphatic dithiocarboxylic acids, and dialkylthiocarbamic acids and dialkyldithiocarbamic acids are included in the aliphatic thiocarbamic acids and the aliphatic dithiocarbamic acids, respectively. Examples of the aliphatic groups in these sulfur-containing compounds include alkyl groups and alkenyl groups that have from 1 to 12 carbon atoms. In the dialkylthiocarbamic acids and the dialkyldithiocarbamic acids, the alkyl groups may have, for example, from 1 to 12 carbon atoms, preferably from 1 to 4 carbon atoms, and two alkyl groups may be the same or different. Further, for example, when the element M¹ is Ag and the element Z is S, specific examples of a compound having an Ag—S bond include silver dimethyldithiocarbamate, silver diethyldithiocarbamate (Ag(DDTC)), and silver ethyl xanthate (Ag(EX)).

The element M²-containing salt in the first mixture may be a compound containing the element M² and the element Z, or a compound having an M²-Z bond. The M²-Z bond may be any of a covalent bond, an ionic bond, a coordinate bond, and the like. Examples of the compound containing the element M² and the element Z include element M²-containing salts of sulfur-containing compounds, and the compound containing the element M² and the element Z may be an organic acid salt, inorganic acid salt, organic metal compound, or the like of the element M². Examples of the sulfur-containing compounds include thiocarbamic acids, dithiocarbamic acids, thiocarbonic acids, dithiocarbonic acids (xanthic acid), trithiocarbonic acids, thiocarboxylic acids, dithiocarboxylic acids, and derivatives thereof. Thereamong, at least one selected from the group consisting of xanthic acid and derivatives thereof is preferred because these compounds are decomposed at a relatively low temperature. Specific examples of the sulfur-containing compounds are the same as described above. Further, for example, when the element M² is In and the element Z is S, specific examples of a compound having an In—S bond include indium tris(dimethyldithiocarbamate), indium tris(diethyldithiocarbamate) (In(DDTC)₃), indium chloro-bis(diethyldithiocarbamate), and indium ethyl xanthate (In(EX)₃). Moreover, for example, when the element M² is Ga and the element Z is S, specific examples of a compound having a Ga—S bond include gallium tris(dimethyldithiocarbamate), gallium tris(diethyldithiocarbamate) (Ga(DDTC)₃), gallium chloro-bis(diethyldithiocarbamate), and gallium ethyl xanthate (Ga(EX)₃).

Examples of the organic solvent in the first mixture include: amines containing a hydrocarbon group having from 4 to 20 carbon atoms, such as alkylamines and alkenylamines having from 4 to 20 carbon atoms; thiols containing a hydrocarbon group having from 4 to 20 carbon atoms, such as alkylthiols and alkenylthiols having from 4 to 20 carbon atoms; and phosphines containing a hydrocarbon group having from 4 to 20 carbon atoms, such as alkylphosphines and alkenylphosphines having from 4 to 20 carbon atoms, and the first mixture preferably contains at least one selected from the group consisting of these organic solvents. These organic solvents may, for example, eventually modify the surfaces of the resulting first semiconductor nanoparticles. These organic solvents may be used in combination of two or more thereof and, for example, a mixed solvent of a combination of at least one selected from thiols containing a hydrocarbon group having from 4 to 20 carbon atoms and at least one selected from amines containing a hydrocarbon group having from 4 to 20 carbon atoms may be used. These organic solvents may also be used as a mixture with other organic solvent. When the organic solvent contains any of the above-described thiols and any of the above-described amines, a content volume ratio of the thiol with respect to the amine (thiol/amine) is, for example, higher than 0 but 1 or lower, preferably from 0.007 to 0.2.

A ratio (M¹/M²) of a total number of element M¹ atoms with respect to a total number of element M² atoms contained in the first mixture may be, for example, from 0.1 to 2.5, and it is preferably from 0.2 to 2.0, more preferably from 0.3 to 1.5. Further, in the composition of the first mixture, a ratio (M¹/Z) of a total number of element M¹ atoms with respect to a total number of element Z atoms may be, for example, from 0.27 to 1.0, and it is preferably from 0.35 to 0.5. When the first mixture contains In and Ga as the element M², a ratio (In/(In+Ga)) of the number of In atoms with respect to a total number of In and Ga atoms may be, for example, from 0.1 to 1.0, and it is preferably from 0.25 to 0.99.

The first mixture may further contain an alkali metal salt. Examples of the alkali metal (M^{a}) include lithium (Li), sodium (Na), potassium (K), rubidium (Rb), and cesium (Cs). For example, when the element M¹ contains Ag, the first mixture preferably contains Li because Li has an ionic radius close to that of Ag. Examples of the alkali metal salt include organic acid salts and inorganic acid salts. Specifically, examples of the inorganic acid salts include nitrates, sulfates, hydrochlorides, and sulfonates, and examples of the organic acid salts include acetates and acetylacetonates. Thereamong, organic acid salts are preferred because they are highly soluble in organic solvents.

When the first mixture contains an alkali metal salt, a ratio (M^{a}/(M¹+M^{a})) of the number of alkali metal atoms with respect to a total number of Ag and alkali metal atoms may be, for example, lower than 1, and it is preferably 0.8 or lower, more preferably 0.4 or lower, still more preferably 0.2 or lower. Further, this ratio may be, for example, higher than 0, and it is preferably 0.05 or higher, more preferably 0.1 or higher.

In the first heat treatment step, a first heat treatment of the first mixture is performed to obtain first semiconductor nanoparticles. The temperature of the first heat treatment may be, for example, from 125° C. to 300° C. The first heat treatment step may include: the temperature raising step of raising the temperature of the first mixture to a temperature in a range of from 125° C. to 300° C.; and the synthesis step of performing a heat treatment of the first mixture at a temperature in a range of from 125° C. to 300° C. for a prescribed time.

The range to which the temperature is raised in the temperature raising step of the first heat treatment step is preferably from 125° C. to 200° C., more preferably from 125° C. to 190° C., still more preferably from 130° C. to 180° C., particularly preferably from 135° C. to 170° C. A temperature increase rate may be adjusted such that the highest temperature during the temperature raising does not exceed the intended temperature, and it is, for example, from 1° C./min to 50° C./min.

The temperature of the heat treatment in the synthesis step of the first heat treatment step is preferably from 125° C. to 200° C., more preferably from 125° C. to 190° C., still more preferably from 130° C. to 180° C., particularly preferably from 135° C. to 170° C. The duration of the first heat treatment in the synthesis step may be, for example, 3 seconds or longer, and it is preferably 1 minute or longer, more preferably 10 minutes or longer. Further, the duration of the first heat treatment may be, for example, 60 minutes or shorter. The duration of the first heat treatment in the synthesis step is defined that it starts at the time when the temperature reaches a temperature set in the above-described range (e.g., at the time when the temperature reaches 150° C. in a case where the set temperature is 150° C.), and ends at the time when an operation for lowering the temperature is carried out. By the synthesis step, a dispersion containing the first semiconductor nanoparticles may be obtained.

The atmosphere of the first heat treatment step is preferably an inert gas atmosphere, particularly an argon atmosphere or a nitrogen atmosphere. By using an inert gas atmosphere, the generation of an oxide as a by-product as well as the oxidation of the surfaces of the resulting first semiconductor nanoparticles may be reduced or prevented.

The method of producing semiconductor nanoparticles may include, after the above-described synthesis step, the cooling step of lowering the temperature of a dispersion containing the resulting first semiconductor nanoparticles. The cooling step starts at the time when an operation for lowering the temperature is carried out, and ends at the time when the dispersion is cooled to 50° C. or lower.

From the viewpoint of inhibiting the generation of a by-product from unreacted element M¹-containing salt, the cooling step preferably includes a period in which the temperature lowering rate is 50° C./min or higher. The temperature lowering rate is preferably 50° C./min or higher particularly at the time when the temperature starts to decrease after the operation for lowering the temperature is carried out.

The atmosphere of the cooling step is preferably an inert gas atmosphere, particularly an argon atmosphere or a nitrogen atmosphere. By using an inert gas atmosphere, the generation of an oxide as a by-product as well as the oxidation of the surfaces of the resulting first semiconductor nanoparticles may be reduced or prevented.

The method of producing semiconductor nanoparticles may also include the separation step of separating the first semiconductor nanoparticles from the dispersion, and may further include the purification step as required. In the separation step, for example, the dispersion containing the first semiconductor nanoparticles may be centrifuged to recover the resulting supernatant containing the first semiconductor nanoparticles. In the purification step, for example, an appropriate organic solvent such as an alcohol may be added to the supernatant obtained in the separation step, and the resultant may be subsequently centrifuged to recover the first semiconductor nanoparticles as a precipitate. The first semiconductor nanoparticles may also be recovered by vaporizing the organic solvent from the supernatant. The thus recovered precipitate may be dried by, for example, vacuum degassing, air drying, or a combination of vacuum degassing and air drying. The air drying may be performed by, for example, leaving the precipitate in the atmosphere at normal temperature and normal pressure and, in this case, the precipitate may be left to stand for 20 hours or longer, for example, about 30 hours. Further, the recovered precipitate may be dispersed in an appropriate organic solvent.

In the method of producing semiconductor nanoparticles, the purification step that includes addition of an organic solvent such as an alcohol and centrifugation may be performed multiple times as required. As the alcohol used for purification, a lower alcohol having 1 to 4 carbon atoms, preferably 1 to 2 carbon atoms, such as methanol, ethanol, n-propyl alcohol, or isopropyl alcohol may be used. When the precipitate is dispersed in an organic solvent, for example, a halogen-based solvent such as chloroform, dichloromethane, dichloroethane, trichloroethane, or tetrachloroethane, or a hydrocarbon-based solvent such as toluene, cyclohexane, hexane, pentane, or octane may be used as the organic solvent. From the viewpoint of internal quantum yield, the organic solvent used for dispersing the precipitate may be a halogen-based solvent.

The first semiconductor nanoparticles obtained in the above-described manner may be in the state of a dispersion or a dry powder.

The method of producing semiconductor nanoparticles may further include the second step of performing a second heat treatment of a second mixture, which contains the first semiconductor nanoparticles, a compound containing a Group 13 element, and a compound containing a Group 16 element, to obtain second semiconductor nanoparticles.

### Second Step

The second step may include: the second mixing step of obtaining a second mixture that contains the first semiconductor nanoparticles, a compound containing a Group 13 element, and a compound containing a Group 16 element; and the second heat treatment step of performing a second heat treatment of the thus obtained second mixture to obtain second semiconductor nanoparticles.

By performing a heat treatment of a mixture that contains the first semiconductor nanoparticles, a compound containing a Group 13 element, and a compound containing a Group 16 element, second semiconductor nanoparticles in which a semiconductor containing the Group 13 element and the Group 16 element is arranged on the surfaces of the first semiconductor nanoparticles may be produced.

In the second mixing step, a second mixture is obtained by mixing the first semiconductor nanoparticles, the compound containing a Group 13 element, and the compound containing a Group 16 element. The first semiconductor nanoparticles used in the second mixing step may be in the form of a dispersion. In a liquid in which the first semiconductor nanoparticles are dispersed, light is not scattered; therefore, the dispersion is generally obtained as a transparent (colored or colorless) dispersion. The second mixture may further contain an organic solvent. When the second mixture contains an organic solvent, the second mixture may be prepared such that the concentration of the first semiconductor nanoparticles therein is, for example, from 5.0×10⁻⁷ mol/L to 5.0×10⁻⁵ mol/L, particularly from 1.0×10⁻⁶ mol/L to 1.0×10⁻⁵ mol/L. It is noted here that the concentration of the first semiconductor nanoparticles is set based on the amount of substance as particles. The “amount of substance as particles” refers to a molar amount assuming a single particle as a huge molecule, and is equal to a value obtained by dividing the number of the nanoparticles contained in a dispersion by Avogadro constant (NA=6.022×10²³). Hereinafter, the amount of substance of nanoparticles is handled in the same manner.

The organic solvent constituting the second mixture may be any organic solvent as in the production of the first semiconductor nanoparticles. The organic solvent may be a surface modifier, or a solution containing a surface modifier. The organic solvent may be, for example: at least one selected from nitrogen-containing compounds containing a hydrocarbon group having from 4 to 20 carbon atoms, which are the surface modifiers described above in relation to the method of producing semiconductor nanoparticles; at least one selected from sulfur-containing compounds containing a hydrocarbon group having from 4 to 20 carbon atoms; or a combination of at least one selected from nitrogen-containing compounds containing a hydrocarbon group having from 4 to 20 carbon atoms and at least one selected from sulfur-containing compounds containing a hydrocarbon group having from 4 to 20 carbon atoms.

The organic solvent constituting the second mixture may contain a halogen-based solvent such as chloroform, or may be substantially a halogen-based solvent. A dispersion of the first semiconductor nanoparticles may be obtained by dispersing the first semiconductor nanoparticles in a halogen-based solvent, and subsequently replacing the solvent with an organic solvent containing a surface modifier, such as a nitrogen-containing compound. The replacement of the solvent may be performed by, for example, adding a surface modifier to the dispersion of the first semiconductor nanoparticles that contains the halogen-based solvent, and subsequently removing the halogen-based solvent at least partially. Specifically, for example, the dispersion that contains the halogen-based solvent and the surface modifier is heat-treated under reduced pressure to remove the halogen-based solvent at least partially, whereby a dispersion of the first semiconductor nanoparticles that contains the surface modifier may be obtained. The reduced pressure condition and the heat-treating temperature in the heat treatment performed under reduced pressure may be set such that the halogen-based solvent is at least partially removed while the surface modifier remains. Specifically, the reduced pressure condition may be, for example, from 1 Pa to 2,000 Pa, and it is preferably from 50 Pa to 500 Pa. Further, the heat-treating temperature may be, for example, from 20° C. to 120° C., and it is preferably from 50° C. to 90° C.

In the compound containing a Group 13 element, the Group 13 element may be at least one selected from the group consisting of boron (B), aluminum (Al), gallium (Ga), indium (In), and thallium (Tl), particularly at least one of Ga or In. Examples of the compound containing a Group 13 element include organic acid salts, inorganic acid salts, and organic metal compounds of Group 13 elements. Specific examples of the compound containing a Group 13 element include nitrates, acetates, sulfates, hydrochlorides, sulfonates, and acetylacetonates, and the compound containing a Group 13 element is preferably an organic acid salt such as an acetate or an acetylacetonate, or an organic metal compound, because such a compound is highly soluble in organic solvents and thus allows reaction to proceed more uniformly.

In the compound containing a Group 16 element, the Group 16 element may be at least one selected from the group consisting of sulfur (S), oxygen (O), selenium (Se), and tellurium (Te), particularly at least one of S or O. Specific examples of a sulfur (S) source include simple substance of sulfur such as high-purity sulfur, and sulfur-containing compounds, for example: thiols such as n-butanethiol, isobutanethiol, n-pentanethiol, n-hexanethiol, octanethiol, decanethiol, dodecanethiol, hexadecanethiol, and octadecanethiol; disulfides such as dibenzyl sulfide; thiourea; alkylthioureas such as 1,3-dimethylthiourea; and thiocarbonyl compounds. Thereamong, when an alkylthiourea such as 1,3-dimethylthiourea is used as an S source, it is believed that a semiconductor containing the Group 13 element and sulfur is sufficiently formed, and the resulting semiconductor nanoparticles exhibit strong band-edge emission.

Specific examples of an oxygen (O) source include oxygen atom-containing compounds and oxygen atom-containing gases. Examples of the oxygen atom-containing compounds include water, alcohols, ethers, carboxylic acids, ketones, and N-oxide compounds, and at least one selected from the group consisting of these compounds is preferred. Examples of the oxygen atom-containing gases include oxygen gas and ozone gas, and at least one selected from the group consisting of these gases is preferred. The oxygen (O) source may be added by dissolving or dispersing an oxygen atom-containing compound in the second mixture, or by blowing an oxygen atom-containing gas into the second mixture. Examples of a selenium (Se) source include simple substance of selenium, phosphine selenium oxide, organic selenium compounds (e.g., dibenzyl diselenide and diphenyl diselenide), and hydrides thereof. Further, examples of a tellurium (Te) source include simple substance of tellurium, phosphine tellurium oxide, and hydrides thereof.

The second mixture may further contain an alkali metal salt as required. The details of the alkali metal salt are as described above. When the second mixture contains an alkali metal salt, a ratio of the number of alkali metal atoms with respect to a sum of the number of alkali metal atoms and the number of Group 13 element atoms in the second mixture may be, for example, 0.01 or higher but lower than 1, or from 0.1 to 0.9. Further, a ratio of the number of Group 16 element atoms with respect to a sum of the number of alkali metal atoms and the number of Group 13 element atoms in the second mixture may be, for example, from 0.25 to 0.75.

The second mixture may further contain a halide of a Group 13 element as required. Examples of the halide of a Group 13 element include fluorides, chlorides, bromides, and iodides of Group 13 elements. One selected from these halides may be used singly, or two or more of these halides may be used in combination, and the second mixture may contain at least a chloride. The Group 13 element may be at least one selected from the group consisting of boron (B), aluminum (Al), gallium (Ga), indium (In), and thallium (Tl), and may contain at least Ga. Specific examples of the halide of a Group 13 element include aluminum fluoride, aluminum chloride, aluminum bromide, aluminum iodide, gallium fluoride, gallium chloride, gallium bromide, gallium iodide, indium fluoride, indium chloride, indium bromide, and indium iodide. Thereamong, gallium chloride is more preferred.

The halide of a Group 13 element may be present in an amount of, for example, from 0.01 to 20, preferably from 0.05 to 5, in terms of the molar ratio of the halide of a Group 13 element with respect to the first semiconductor nanoparticles.

In the second heat treatment step, the second semiconductor nanoparticles may be produced by a method in which: the temperature of the dispersion containing the first semiconductor nanoparticles is raised such that a peak temperature thereof is from 200° C. to 310° C.; once the temperature of the dispersion reached the peak temperature, a mixed solution, which is prepared in advance by dispersing or dissolving a compound containing a Group 13 element, a compound containing a Group 16 element and, as required, an alkali metal salt in an organic solvent, is added to the dispersion in small portions with the peak temperature being maintained; and the temperature is subsequently lowered (slow injection method). In this case, the second heat treatment proceeds immediately after the second mixture is obtained as a result of mixing the dispersion containing the first semiconductor nanoparticles and the mixed solution. The mixed solution may be added at a rate of from 0.1 mL/hr to 10 mL/hr, particularly from 1 mL/hr to 5 mL/hr. As required, the peak temperature may be maintained even after the completion of the addition of the mixed solution.

In the slow injection method, when the peak temperature is 200° C. or higher, the second semiconductor nanoparticles tend to be produced sufficiently because of, for example, sufficient progress of the chemical reaction for the generation of the second semiconductor nanoparticles. When the peak temperature is 310° C. or lower, a change in the properties of the first semiconductor nanoparticles is inhibited, so that favorable band-edge emission tends to be obtained. The duration of maintaining the peak temperature may be set at a total of from 1 minute to 300 minutes, particularly from 10 minutes to 120 minutes, after the start of the addition of the mixed solution. This retention time of the peak temperature is selected in relation to the peak temperature. The retention time is extended when the peak temperature is lower while the retention time is shortened when the peak temperature is higher, whereby favorable second semiconductor nanoparticles are likely to be produced. A temperature increase rate and a temperature lowering rate are not particularly limited, and the temperature may be lowered by, for example, stopping heating with a heat source (e.g., an electric heater) and thereby allowing the resultant to cool after maintaining the peak temperature for a prescribed time.

Alternatively, in the second heat treatment step, a semiconductor containing a Group 13 element and a Group 16 element may be formed on the surfaces of the first semiconductor nanoparticles by mixing the first semiconductor nanoparticles with a compound containing the Group 13 element, a compound containing the Group 16 element and, as required, an alkali metal salt to obtain a second mixture, and subsequently performing a second heat treatment of this second mixture (heating-up method). Specifically, heating may be performed by slowly raising the temperature of the second mixture such that a peak temperature of the second heat treatment is from 200° C. to 310° C., maintaining the peak temperature for from 1 minute to 300 minutes, preferably from 10 minutes to 120 minutes, and then slowly lowering the temperature. The temperature increase rate may be, for example, from 1° C./min to 50° C./min; however, in order to minimize a change in the properties of the first semiconductor nanoparticles caused by continuous heat treatment, the temperature increase rate is preferably from 50° C./min to 100° C./min until the temperature reaches 200° C. In the case of further raising the temperature beyond 200° C., the subsequent temperature increase rate is preferably set at from 1° C./min to 5° C./min. The temperature lowering rate may be, for example, from 1° C./min to 50° C./min. The advantages of maintaining the peak temperature in the above-prescribed range are as described above for the slow injection method.

According to the heating-up method, as compared to a case of producing the second semiconductor nanoparticles by the slow injection method, semiconductor nanoparticles exhibiting stronger band-edge emission tend to be obtained.

In either of the above methods, an addition ratio of the compound containing a Group 13 element and the compound containing a Group 16 element may be determined in correspondence to the stoichiometric composition ratio of a compound semiconductor composed of the Group 13 element and the Group 16 element, and the addition ratio does not necessarily have to be the stoichiometric composition ratio. For example, the addition ratio of the compound containing a Group 16 element with respect to the compound containing a Group 13 element may be from 0.75 to 1.5.

Further, in order to allow a semiconductor of a desired thickness to be formed on the first semiconductor nanoparticles contained in the dispersion, addition amounts are selected taking into consideration the amount of the first semiconductor nanoparticles contained in the dispersion. For example, the addition amounts of the compound containing a Group 13 element and the compound containing a Group 16 element may be determined such that a compound semiconductor having a stoichiometric composition composed of the Group 13 element and the Group 16 element is generated in an amount of from 1 μmol to 10 mmol, particularly from 5 μmol to 1 mmol, with respect to 10 nmol of the first semiconductor nanoparticles in terms of the amount of substance as particles.

The atmosphere of the second heat treatment step is, for example, an inert gas atmosphere, particularly preferably an argon atmosphere or a nitrogen atmosphere. By using an inert gas atmosphere, the generation of an oxide as a by-product as well as the oxidation of the surfaces of the resulting second semiconductor nanoparticles may be reduced or prevented.

In the second mixture, it is preferred to form a semiconductor composed of substantially gallium and sulfur by using gallium acetylacetonate as the compound containing a Group 13 element, and simple substance of sulfur, thiourea, dibenzyl disulfide, or alkylthiourea as the compound containing a Group 16 element, along with a mixed solution of oleylamine and dodecanethiol, or an alkylamine or alkenylamine having from 4 to 20 carbon atoms as an organic solvent.

The second semiconductor nanoparticles obtained in the second heat treatment step may be separated from the dispersion and, as required, may be further purified and dried. The methods of separation, purification, and drying are as described above in relation to the first semiconductor nanoparticles; therefore, detailed description thereof is omitted here.

The method of producing semiconductor nanoparticles may further include the third step of performing a third heat treatment of the second semiconductor nanoparticles in the presence of a halide of a Group 13 element to obtain third semiconductor nanoparticles.

### Third Step

The third step may include the third heat treatment step of performing, in the presence of a halide of a Group 13 element, a third heat treatment of the second semiconductor nanoparticles obtained in the above-described second step to obtain third semiconductor nanoparticles.

Examples of the halide of a Group 13 element include fluorides, chlorides, bromides, and iodides of Group 13 elements. One selected from these halides may be used singly, or two or more of these halides may be used in combination, and the halide of a Group 13 element may contain at least a chloride. The Group 13 element may be at least one selected from the group consisting of boron (B), aluminum (Al), gallium (Ga), indium (In), and thallium (Tl), and may contain at least Ga. Specific examples of the halide of a Group 13 element include aluminum fluoride, aluminum chloride, aluminum bromide, aluminum iodide, gallium fluoride, gallium chloride, gallium bromide, gallium iodide, indium fluoride, indium chloride, indium bromide, and indium iodide. Thereamong, gallium chloride is more preferred. It is noted here that the Group 13 element in the halide of a Group 13 element is preferably the same as the Group 13 element in the above-described second mixture.

The halide of a Group 13 element may be present in an amount of, for example, from 0.01 to 50, preferably from 0.1 to 10, in terms of the molar ratio of the halide of a Group 13 element with respect to the second semiconductor nanoparticles.

The temperature of the third heat treatment in the third heat treatment step may be, for example, from 200° C. to 320° C. The third heat treatment step may include: the temperature raising step of raising the temperature to a temperature in a range of from 200° C. to 320° C.; and the modification step of performing a heat treatment at a temperature in a range of from 200° C. to 320° C. for a predetermined time.

The third heat treatment step may further include, prior to the temperature raising step, the pre-heat treatment step of performing a heat treatment at a temperature of from 60° C. to 100° C. The temperature of the heat treatment in the pre-heat treatment step may be, for example, from 70° C. to 90° C. The duration of the heat treatment in the pre-heat treatment step may be, for example, from 1 minute to 30 minutes, preferably from 5 minutes to 20 minutes.

The range to which the temperature is raised in the temperature raising step of the third heat treatment step may be from 200° C. to 320° C., preferably from 230° C. to 290° C. A temperature increase rate may be adjusted such that the highest temperature during the temperature raising does not exceed the intended temperature, and it is, for example, from 1° C./min to 50° C./min.

The temperature of the heat treatment in the modification step of the third heat treatment step may be from 200° C. to 320° C., preferably from 230° C. to 290° C. The duration of the heat treatment in the modification step may be, for example, 3 seconds or longer, preferably 1 minute or longer, 10 minutes or longer, 30 minutes or longer, 60 minutes or longer, or 90 minutes or longer. Further, the duration of the heat treatment may be, for example, 300 minutes or shorter, preferably 180 minutes or shorter, or 150 minutes or shorter. The duration of the heat treatment in the modification step is defined that it starts at the time when the temperature reaches a temperature set in the above-described range (e.g., at the time when the temperature reaches 250° C. in a case where the set temperature is 250° C.), and ends at the time when an operation for lowering the temperature is carried out.

The atmosphere of the third heat treatment is preferably an inert gas atmosphere, particularly an argon atmosphere or a nitrogen atmosphere. By using an inert gas atmosphere, the generation of an oxide as a by-product as well as the oxidation of the surfaces of the resulting third semiconductor nanoparticles may be reduced or prevented.

The method of producing semiconductor nanoparticles may include, after the above-described modification step, the cooling step of lowering the temperature of a dispersion containing the resulting third semiconductor nanoparticles. The cooling step starts at the time when an operation for lowering the temperature is carried out, and ends at the time when the dispersion is cooled to 50° C. or lower.

The cooling step may include a period in which the temperature lowering rate is 50° C./min or higher. The temperature lowering rate may be 50° C./min or higher particularly at the time when the temperature starts to decrease after the operation for lowering the temperature is carried out.

The atmosphere of the cooling step is preferably an inert gas atmosphere, particularly an argon atmosphere or a nitrogen atmosphere. By using an inert gas atmosphere, the generation of an oxide as a by-product as well as the oxidation of the surfaces of the resulting third semiconductor nanoparticles may be reduced or prevented.

The third step may also include the third mixing step of mixing the second semiconductor nanoparticles with a halide of a Group 13 element to obtain a third mixture. The halide of a Group 13 element used in the third mixture and the conditions for performing the third heat treatment of the third mixture are as described above. The second semiconductor nanoparticles used in the third mixing step may be in the form of a dispersion. In a liquid in which the second semiconductor nanoparticles are dispersed, light is not scattered; therefore, the dispersion is generally obtained as a transparent (colored or colorless) dispersion. The third mixture may further contain an organic solvent. When the third mixture contains an organic solvent, the third mixture may be prepared such that the concentration of the second semiconductor nanoparticles therein is, for example, from 5.0×10⁻⁷ mol/L to 5.0×10⁻⁵ mol/L, particularly from 1.0×10⁻⁶ mol/L to 1.0×10⁻⁵ mol/L. It is noted here that the concentration of the second semiconductor nanoparticles is set based on the amount of substance as particles. The organic solvent constituting the third mixture is the same as the one used the production of the second semiconductor nanoparticles. The dispersion of the second semiconductor nanoparticles may be prepared such that the concentration of the particles in the dispersion is, for example, from 5.0×10⁻⁷ mol/L to 5.0×10⁻⁵ mol/L, particularly from 1.0×10⁻⁶ mol/L to 1.0×10⁻⁵ mol/L.

The content of the halide of a Group 13 element in the third mixture with respect to the molar amount of the second semiconductor nanoparticles may be, for example, from 0.01 to 50, and it is preferably from 0.1 to 10.

The method of producing semiconductor nanoparticles may also include the separation step of separating the third semiconductor nanoparticles from the dispersion, and may further include the purification step as required. The separation step and the purification step are as described above in relation to the first semiconductor nanoparticles; therefore, detailed description thereof is omitted here.

The method of producing semiconductor nanoparticles may further include the surface modification step. The surface modification step may include bringing the thus obtained third semiconductor nanoparticles into contact with a surface modifier.

In the surface modification step, the third semiconductor nanoparticles may be brought into contact with the surface modifier by, for example, mixing the third semiconductor nanoparticles and the surface modifier. In the surface modification step, a ratio of the amount of the surface modifier with respect to the third semiconductor nanoparticles may be, for example, 1×10⁻⁸ moles or more, and it is preferably from 2×10⁻⁸ moles to 5×10⁻⁸ moles, with respect to 1×10⁻⁸ moles of the third semiconductor nanoparticles. The temperature of the contact may be, for example, from 0° C. to 300° C., and it is preferably from 10° C. to 300° C. The duration of the contact may be, for example, from 10 seconds to 10 days, and it is preferably from 1 minute to 1 day. The atmosphere of the contact may be an inert gas atmosphere, and it is particularly preferably an argon atmosphere or a nitrogen atmosphere.

Specific examples of the surface modifier used in the surface modification step include an amino alcohol containing a hydrocarbon group having from 2 to 20 carbon atoms, an ionic surface modifier, a nonionic surface modifier, a nitrogen-containing compound containing a hydrocarbon group having from 4 to 20 carbon atoms, a sulfur-containing compound containing a hydrocarbon group having from 4 to 20 carbon atoms, an oxygen-containing compound containing a hydrocarbon group having from 4 to 20 carbon atoms, a phosphorus-containing compound containing a hydrocarbon group having from 4 to 20 carbon atoms, and a halide of a Group 2, 12, or 13 element. These surface modifiers may be used singly, or in combination of two or more different kinds thereof.

The amino alcohol used as the surface modifier may be any compound as long as it has an amino group and an alcoholic hydroxyl group and contains a hydrocarbon group having from 2 to 20 carbon atoms. The number of carbon atoms in the amino alcohol is preferably 10 or less, more preferably 6 or less. The hydrocarbon group constituting the amino alcohol may be derived from a hydrocarbon such as a linear, branched, or cyclic alkane, alkene, or alkyne. The expression “derived from a hydrocarbon” used herein means that the hydrocarbon group is formed by removing at least two hydrogen atoms from the hydrocarbon. Specific examples of the amino alcohol include amino ethanol, amino propanol, amino butanol, amino pentanol, amino hexanol, and amino octanol. The amino group of the amino alcohol binds to the surfaces of semiconductor nanoparticles and the hydroxyl group is exposed on the particle outermost surface on the opposite side, as a result of which the polarity of the semiconductor nanoparticles is changed, and the dispersibility in alcohol-based solvents (e.g., methanol, ethanol, propanol, and butanol) is improved.

Examples of the ionic surface modifier used as the surface modifier include nitrogen-containing compounds, sulfur-containing compounds, and oxygen-containing compounds, which contain an ionic functional group in the respective molecules. The ionic functional group may be either cationic or anionic, and the ionic surface modifier preferably contains at least a cationic group. With regard to specific examples of the surface modifier and a surface modification method, reference may be made to, for example, Chemistry Letters, Vol. 45, pp 898-900, 2016.

The ionic surface modifier may be, for example, a sulfur-containing compound containing a tertiary or quaternary alkylamino group. The number of carbon atoms of the alkyl group in the alkylamino group may be, for example, from 1 to 4. The sulfur-containing compound may also be an alkyl or alkenylthiol having from 2 to 20 carbon atoms. Specific examples of the ionic surface modifier include hydrogen halides of dimethylaminoethanethiol, halogen salts of trimethylammonium ethanethiol, hydrogen halides of dimethylaminobutanethiol, and halogen salts of trimethylammonium butanethiol.

Examples of the nonionic surface modifier used as the surface modifier include nitrogen-containing compounds, sulfur-containing compounds, and oxygen-containing compounds, which have a nonionic functional group containing an alkylene glycol unit, an alkylene glycol monoalkyl ether unit, or the like. The number of carbon atoms of the alkylene group in the alkylene glycol unit may be, for example, from 2 to 8, and it is preferably from 2 to 4. Further, the number of repeating alkylene glycol units may be, for example, from 1 to 20, and it is preferably from 2 to 10. The nitrogen-containing compounds, the sulfur-containing compounds, and the oxygen-containing compounds, which constitute the nonionic surface modifier, may contain an amino group, a thiol group, and a hydroxy group, respectively. Specific examples of the nonionic surface modifier include methoxytriethyleneoxy ethanethiol and methoxyhexaethyleneoxy ethanethiol.

Examples of the nitrogen-containing compound containing a hydrocarbon group having from 4 to 20 carbon atoms include amines and amides. Examples of the sulfur-containing compound containing a hydrocarbon group having from 4 to 20 carbon atoms include thiols. Examples of the oxygen-containing compound containing a hydrocarbon group having from 4 to 20 carbon atoms include carboxylic acids, alcohols, ethers, aldehydes, and ketones. Examples of the phosphorus-containing compound containing a hydrocarbon group having from 4 to 20 carbon atoms include trialkyl phosphines, triaryl phosphines, trialkyl phosphine oxides, and triaryl phosphine oxides.

Examples of the halide of a Group 2, 12, or 13 element include magnesium chloride, calcium chloride, zinc chloride, cadmium chloride, aluminum chloride, and gallium chloride.

The semiconductor nanoparticles produced by the method of producing semiconductor nanoparticles may contain or consist of the third semiconductor nanoparticles. Further, the semiconductor nanoparticles produced by the method may contain or consist of the third semiconductor nanoparticles that are surface-modified.

### Semiconductor Nanoparticles

The semiconductor nanoparticles contain a first semiconductor containing an element M¹, an element M², and an element Z, and a second semiconductor containing a Group 13 element and a Group 16 element may be arranged on the surface of the first semiconductor. The element M¹ is at least one element selected from the group consisting of Ag, Cu, Au, and alkali metals, and may contain at least Ag. The element M² is at least one element selected from the group consisting of Al, Ga, In, and Tl, and may contain at least one of In or Ga. The element Z may contain at least one element selected from the group consisting of S, Se, and Te. The semiconductor nanoparticles, when irradiated with a light having a wavelength in a range of from 350 nm to 500 nm, exhibit band-edge emission with a longer wavelength than that of the irradiated light, and the band-edge emission component may have a purity of 70% or more and an internal quantum yield of 15% or more. The details of the purity and the internal quantum yield of the band-edge emission component are described below.

The semiconductor nanoparticles may be produced as third semiconductor nanoparticles by, for example, the above-described method of producing semiconductor nanoparticles.

The semiconductor nanoparticles, when irradiated with a light having a wavelength in a range of from 350 nm to 500 nm, exhibit band-edge emission having an emission peak wavelength on the longer wavelength side than the irradiated light, together with a high band-edge emission purity and a high internal quantum yield of the band-edge emission. This is believed to be because, for example, the crystal structure of the first semiconductor existing in the central parts of the semiconductor nanoparticles is substantially tetragonal, and the second semiconductor containing a Group 13 element and a Group 16 element, which is arranged on the surface of the first semiconductor, has a crystal structure with few lattice defects of the Group 13 element. The second semiconductor may be a semiconductor having a higher composition ratio of a Group 13 element than the first semiconductor, a semiconductor having a lower composition ratio of the element M¹ than the first semiconductor, or a semiconductor composed of substantially a Group 13 element and a Group 16 element. Further, in the semiconductor nanoparticles, a deposit containing the second semiconductor may be arranged on the surfaces of particles containing the first semiconductor, and the particles containing the first semiconductor may be covered with the deposit containing the second semiconductor. Moreover, the semiconductor nanoparticles may have a core-shell structure in which, for example, a particle containing the first semiconductor constitutes a core and a deposit containing the second semiconductor is arranged as a shell on the surface of the core.

The first semiconductor constituting the semiconductor nanoparticles contains a semiconductor containing an element M¹, an element M², and an element Z. The element M¹ is at least one element selected from the group consisting of Ag, Cu, Au, and alkali metals, and may contain at least Ag. The element M² is at least one element selected from the group consisting of Al, Ga, In, and Tl, and may contain at least one of In or Ga. The element Z may contain at least one element selected from the group consisting of S, Se, and Te. The first semiconductor may contain, for example, Ag, at least one of In or Ga, and S. Semiconductor nanoparticles that contain Ag, In, and S, and have a tetragonal, hexagonal, or orthorhombic crystal structure are generally introduced in literature and the like as semiconductor nanoparticles represented by a composition formula AgInS₂. However, such semiconductor nanoparticles do not actually have a stoichiometric composition represented by the above-described general formula and, particularly, the ratio (Ag/In+Ga) of the number of Ag atoms with respect to the number of In and Ga atoms may be lower than 1, or conversely, higher than 1. In addition, a sum of the number of Ag atoms and the number of In and Ga atoms is not always equal to the number of S atoms. Therefore, in the present specification, where it is irrelevant whether or not a semiconductor containing specific elements has a stoichiometric composition, the composition of the semiconductor is represented by a formula in which the constituent elements are connected by “—” as in Ag—In—Ga—S. Accordingly, the semiconductor nanoparticles of the present embodiment may be considered as, for example, Ag—In—S, or Ag—In—Ga—S or Ag—Ga—S where In that is a Group 13 element is partially or entirely Ga that is also a Group 13 element.

It is noted here that the first semiconductor containing the above-described elements and having a hexagonal crystal structure is a wurtzite-type semiconductor, and the first semiconductor having a tetragonal crystal structure is a chalcopyrite-type semiconductor. The crystal structure is identified by, for example, measuring the X-ray diffraction (XRD) pattern obtained by XRD analysis. Specifically, an XRD pattern obtained from the semiconductor nanoparticles is compared with known XRD patterns of semiconductor nanoparticles represented by a composition formula AgInS₂, or with XRD patterns determined by simulation using crystal structure parameters. If the pattern of the semiconductor nanoparticles corresponds to any of the known patterns and simulated patterns, the crystal structure of the semiconductor nanoparticles is said to be that of the corresponding known or simulated pattern.

An aggregate of the semiconductor nanoparticles may contain a mixture of semiconductor nanoparticles that contain first semiconductors having different crystal structures. In this case, peaks derived from the plural kinds of crystal structures are observed in the XRD pattern. In the semiconductor nanoparticles of one embodiment, the first semiconductor may be composed of substantially tetragonal crystals, and a peak corresponding to the tetragonal crystals is observed, while substantially no peak derived from other crystal structure may be observed.

In the composition of the first semiconductor, a total content ratio of the element M¹ may be, for example, from 10% by mole to 30% by mole, and it is preferably from 15% by mole to 25% by mole. In the composition of the first semiconductor, a total content ratio of the element M² may be, for example, from 15% by mole to 35% by mole, and it is preferably from 20% by mole to 30% by mole. In the composition of the first semiconductor, a total content ratio of the element Z may be, for example, from 35% by mole to 55% by mole, and it is preferably from 40% by mole to 55% by mole.

The first semiconductor may have a composition represented by, for example, the following formula (1):

$${M}_{q}^{1} {M}^{2} {Z}_{( q + 3 ) / 2} , \qquad ( 1 )$$

wherein, 0.2<q≤1.2.

The element M¹ of the first semiconductor contains at least Ag that may be partially substituted such that the element M¹ further contains at least one of Cu, Au, or an alkali metal, and the element M¹ may be composed of substantially Ag. The term “substantially” used herein indicates that a ratio of the number of atoms of elements other than Ag is, for example, 10% or lower, preferably 5% or lower, more preferably 1% or lower, with respect to a total number of atoms of Ag and the elements other than Ag.

Further, the first semiconductor may contain substantially Ag and an alkali metal (hereinafter may be referred to as “M^{a}”) as constituent elements corresponding to the element M¹. The term “substantially” used herein indicates that a ratio of the number of atoms of elements other than Ag and the alkali metal is, for example, 10% or lower, preferably 5% or lower, more preferably 1% or lower, with respect to a total number of atoms of Ag, the alkali metal, and the elements other than Ag and the alkali metal. Examples of the alkali metal include lithium (Li), sodium (Na), potassium (K), rubidium (Rb), and cesium (Cs). The alkali metal may be a monovalent cation in the same manner as Ag and, therefore, may partially substitute Ag in the composition of the semiconductor nanoparticles. Particularly, Li is preferably used because it has substantially the same ionic radius as Ag. Partial substitution of Ag in the composition of the first semiconductor leads to, for example, a widened band gap and a shift of the emission peak wavelength to the shorter wavelength side. In addition, it is believed that, although the details are unclear, the lattice defects of the first semiconductor are reduced and the internal quantum yield of the band-edge emission is improved. When the first semiconductor contains an alkali metal, the first semiconductor may contain at least Li.

When the first semiconductor contains Ag and an alkali metal (M^{a}), a content ratio of the alkali metal in the composition of the first semiconductor is, for example, higher than 0% by mole but lower than 30% by mole, preferably from 1% by mole to 25% by mole. Further, in the composition of the first semiconductor, a ratio (M^{a}/(Ag+M^{a})) of the number of alkali metal (M^{a}) atoms with respect to a total of the number of Ag atoms and the number of alkali metal (M^{a}) atoms is, for example, lower than 1, preferably 0.8 or lower, more preferably 0.4 or lower, still more preferably 0.2 or lower. This ratio is, for example, higher than 0, preferably 0.05 or higher, more preferably 0.1 or higher.

The element M² contains at least one of In or Ga that may be partially substituted such that the element M² further contains at least one of Al or Tl, and the element M² may be composed of substantially In and Ga. The term “substantially” used herein indicates that a ratio of the number of atoms of elements other than In and Ga is, for example, 10% or lower, preferably 5% or lower, more preferably 1% or lower, with respect to a total number of atoms of In, Ga, and the elements other than In and Ga.

In the first semiconductor, a ratio (In/(In+Ga)) of the number of In atoms with respect to a total number of In and Ga atoms may be, for example, 0.01 or higher but lower than 1, and it is preferably from 0.1 to 0.99. When the ratio of the number of In atoms with respect to a total number of In and Ga atoms is in this prescribed range, a short emission peak wavelength (e.g., 545 nm or shorter) may be obtained. Further, a ratio (Ag/(In+Ga)) of the number of Ag atoms with respect to a total number of In and Ga atoms is, for example, from 0.3 to 1.2, preferably from 0.5 to 1.1.

The element Z contains S that may be partially substituted such that the element Z further contains at least one of Se or Te, and the element Z may be composed of substantially S. The term “substantially” used herein indicates that a ratio of the number of atoms of elements other than S is, for example, 10% or lower, preferably 5% or lower, more preferably 1% or lower, with respect to a total number of atoms of S and the elements other than S. A ratio (element Z/(element M¹+element M²)) of the number of atoms of element Z with respect to a total number of atoms of the elements M¹ and M² is, for example, from 0.8 to 1.5, preferably from 0.9 to 1.2.

The first semiconductor may be composed of substantially Ag, In, Ga, S, and the above-described elements partially substituting these elements. The term “substantially” used herein takes into consideration that elements other than Ag, In, Ga, S, and the elements partially substituting these elements may be unavoidably incorporated due to, for example, contamination with impurities.

When the first semiconductor is composed of substantially Ag, In, Ga, S, and the above-described elements partially substituting these elements, the first semiconductor may have a composition represented by, for example, the following formula (2):

$${( {Ag}_{p} {M}_{( 1 - p )}^{a} )}_{q} {In}_{r} {Ga}_{( 1 - r )} {S}_{( q + 3 ) / 2} , \qquad ( 2 )$$

wherein, p, q, and r satisfy 0<p≤1, 0.20<q≤1.2, and 0<r<1; and M^{a} represents an alkali metal.

The semiconductor nanoparticles may have a semiconductor (second semiconductor) containing a Group 13 element and a Group 16 element on the surface of the first semiconductor. The second semiconductor may be a semiconductor having a larger band-gap energy than that of the first semiconductor.

The Group 13 element in the second semiconductor may be at least one selected from the group consisting of boron (B), aluminum (Al), gallium (Ga), indium (In), and thallium (Tl). Further, the Group 16 element in the second semiconductor may be at least one selected from the group consisting of sulfur (S), oxygen (O), selenium (Se), and tellurium (Te).

The composition of a semiconductor contained in the second semiconductor may have a higher molar content of the Group 13 element than the molar content of the element M² in the composition of the first semiconductor. A ratio of the molar content of the Group 13 element in the composition of the second semiconductor with respect to the molar content of the element M² in the composition of the first semiconductor may be, for example, higher than 1 but 5 or lower, preferably 1.1 or higher but 3 or lower.

Further, the composition of the second semiconductor may have a lower molar content of the element M¹ than the composition of the first semiconductor. A ratio of the molar content of the element M¹ in the composition of the second semiconductor with respect to the molar content of the element M¹ in the composition of the first semiconductor may be, for example, from 0.1 to 0.7, preferably 0.2 or higher but 0.5 or lower. The ratio of the molar content of the element M¹ in the composition of the second semiconductor may be, for example, 0.5 or lower, preferably 0.2 or lower, 0.1 or lower, or substantially 0. The term “substantially” used herein indicates that, when a total number of atoms of all elements contained in the second semiconductor is taken as 100%, a ratio of the number of element M¹ atoms is, for example, 10% or lower, preferably 5% or lower, more preferably 1% or lower. Further, the second semiconductor may be a semiconductor composed of substantially a Group 13 element and a Group 16 element. The term “substantially” used herein indicates that, when a total number of atoms of all elements contained in the semiconductor containing the Group 13 element and the Group 16 element is taken as 100%, a ratio of the number of atoms of elements other than the Group 13 element and the Group 16 element is, for example, 10% or lower, preferably 5% or lower, more preferably 1% or lower.

The second semiconductor may further contain an alkali metal (M^{a}) in addition to the Group 13 element and the Group 16 element. The alkali metal contained in the second semiconductor may include at least lithium. When the second semiconductor contains an alkali metal, a ratio of the number of alkali metal atoms with respect to a sum of the number of alkali metal atoms and the number of Ga atoms may be, for example, 0.01 or higher but lower than 1, or from 0.1 to 0.9. Further, a ratio of the number of S atoms with respect to a sum of the number of alkali metal atoms and the number of Ga atoms may be, for example, from 0.25 to 0.75.

The second semiconductor may be formed by selecting its composition and the like in accordance with the band-gap energy of the above-described first semiconductor. Alternatively, when the composition and the like of the second semiconductor are predetermined, the first semiconductor may be designed such that the band-gap energy of the first semiconductor is smaller than that of the second semiconductor. Generally, a semiconductor composed of Ag—In—S has a band-gap energy of from 1.8 eV to 1.9 eV.

The second semiconductor may have a crystal system conforming to that of the first semiconductor, and may have a lattice constant that is the same as or close to that of the first semiconductor. The second semiconductor which has a crystal system conforming to that of the first semiconductor and a lattice constant close to that of the first semiconductor (including a case where a multiple of the lattice constant of the second semiconductor is similar to the lattice constant of the semiconductor contained in the first semiconductor) may favorably cover the periphery of the first semiconductor. For example, the semiconductor contained in the first semiconductor generally has a tetragonal crystal system, and examples of a crystal system conforming thereto include a tetragonal crystal system and an orthorhombic crystal system. When Ag—In—S has a tetragonal crystal system, it is preferred that the lattice constants of its constituent elements be 0.5828 nm, 0.5828 nm, and 1.119 nm, respectively; and that the second semiconductor covering this Ag—In—S have a tetragonal or cubic crystal system, and its lattice constants or multiple thereof be close to the lattice constants of Ag—In—S. Alternatively, the second semiconductor may be amorphous.

Whether or not an amorphous second semiconductor is formed may be verified by observing the semiconductor nanoparticles by HAADF-STEM. When the amorphous second semiconductor is formed, specifically, in HAADF-STEM, a central part is observed with a regular pattern, such as a stripe pattern or a dot pattern, and its surrounding part is observed with no regular pattern. According to HAADF-STEM, a substance having a regular structure as in the case of a crystalline substance is observed as an image having a regular pattern, while a substance having no regular structure as in the case of an amorphous substance is not observed as an image having a regular pattern. Therefore, when the second semiconductor is amorphous, the second semiconductor may be observed as a part that is clearly different from the first semiconductor observed as an image having a regular pattern (the first semiconductor may have a crystal structure of a tetragonal system or the like).

Whether or not an amorphous second semiconductor is formed may also be verified by observing the semiconductor nanoparticles of the present embodiment under a high-resolution transmission electron microscope (HRTEM). In an image obtained by HRTEM, the first semiconductor portion is observed as a crystal lattice image (an image having a regular pattern) while the second semiconductor portion is not observed as a crystal lattice image, and the second semiconductor portion is observed as a part having a black and white contrast but no regular pattern.

Meanwhile, the second semiconductor preferably does not form a solid solution with the first semiconductor. If the second semiconductor forms a solid solution with the first semiconductor, because the second semiconductor and the first semiconductor are integrated together, the mechanism of the present embodiment, in which band-edge emission is obtained by covering the first semiconductor with the second semiconductor and thereby modifying the surface state of the first semiconductor, cannot be attained. For example, it has been confirmed that band-edge emission cannot be obtained from the first semiconductor even when the surface of the first semiconductor composed of Ag—In—S is covered with zinc sulfide (Zn—S) having a stoichiometric or non-stoichiometric composition. Zn—S, in its relationship with Ag—In—S, satisfies the above-described conditions in terms of band-gap energy, and gives a type-I band alignment. Nevertheless, band-edge emission was not obtained from the above-described specific semiconductor, and it is surmised that the reason for this is because the semiconductor of the first semiconductor and ZnS formed a solid solution, eliminating the interface between the first semiconductor and the second semiconductor.

The second semiconductor may contain, but not limited to, a combination of In and S, a combination of Ga and S, or a combination of In, Ga, and S, as a combination of Group 13 and Group 16 elements. The combination of In and S may be in the form of indium sulfide, the combination of Ga and S may be in the form of gallium sulfide, and the combination of In, Ga, and S may be in the form of indium gallium sulfide. Indium sulfide constituting the second semiconductor may or may not have a stoichiometric composition (e.g., In₂S₃) and, in this sense, indium sulfide may be hereinafter represented by a formula InSₓ, wherein, x represents an arbitrary number that is not limited to an integer, such as from 0.8 to 1.5. Similarly, gallium sulfide may or may not have a stoichiometric composition (e.g., Ga₂S₃) and, in this sense, gallium sulfide may be hereinafter represented by a formula GaSₓ, wherein, x represents an arbitrary number that is not limited to an integer, such as from 0.8 to 1.5. Indium gallium sulfide may have a composition represented by In_{2(1-y)}Ga_{2y}S₃, wherein, y represents an arbitrary number that is larger than 0 but smaller than 1, or InₚGa₁₋ₚS_{q}, wherein, p represents an arbitrary number that is larger than 0 but smaller than 1, and q represents an arbitrary number that is not limited to an integer.

Indium sulfide has a band-gap energy of from 2.0 eV to 2.4 eV, and indium sulfide with a cubic crystal system has a lattice constant of 1.0775 nm. Gallium sulfide has a band-gap energy of about from 2.5 eV to 2.6 eV, and gallium sulfide with a tetragonal crystal system has a lattice constant of 0.5215 nm. It is noted here, however, that the above-described crystal systems and the like are all reported values, and the second semiconductor does not necessarily satisfy these reported values in the actual semiconductor nanoparticles.

Indium sulfide and gallium sulfide may be preferably used as the semiconductor constituting the second semiconductor arranged on the surface of the first semiconductor. Particularly, gallium sulfide is preferably used because of its large band-gap energy. When gallium sulfide is used, a stronger band-edge emission may be obtained as compared to a case of using indium sulfide.

When the second semiconductor is a semiconductor containing Ga and S, the second semiconductor may have a band-gap energy of, for example, from 2.0 eV to 5.0 eV, particularly from 2.5 eV to 5.0 eV. The band-gap energy of the semiconductor containing Ga and S may be larger than that of the first semiconductor by, for example, about from 0.1 eV to 3.0 eV, particularly about from 0.3 eV to 3.0 eV, more particularly about from 0.5 eV to 1.0 eV. When the difference between the band-gap energy of the semiconductor containing Ga and S and that of the first semiconductor is equal to or greater than the above-described lower limit value, the ratio of emission other than band-edge emission in the emission from the first semiconductor tends to be reduced, resulting in an increase in the ratio of band-edge emission.

When the second semiconductor is a semiconductor containing Ga and S, the second semiconductor may contain an oxygen (O) atom. An oxygen atom-containing semiconductor tends to have a larger band-gap energy than the above-described first semiconductor. The form of such an oxygen atom-containing semiconductor in the second semiconductor is not clear; however, it may be, for example, Ga—O—S or Ga₂O₃.

The second semiconductor may be a semiconductor composed of substantially Ga and S. The term “substantially” used herein indicates that, when a total number of atoms of all elements contained in the semiconductor containing Ga and S is taken as 100%, a ratio of the number of atoms of elements other than Ga and S is, for example, 10% or lower, preferably 5% or lower, more preferably 1% or lower.

The semiconductor nanoparticles may have an average particle size of, for example, 50 nm or smaller. From the viewpoints of the ease of production and the internal quantum yield of band-edge emission, the average particle size is preferably in a range of from 1 nm to 20 nm, more preferably from 1.6 nm to 8 nm, particularly preferably from 2 nm to 7.5 nm.

The average particle size of the semiconductor nanoparticles may be determined from, for example, a TEM image captured using a transmission electron microscope (TEM). The particle size of an individual particle specifically refers to the length of the longest line segment among those line segments that exist inside the particle observed in a TEM image and connect two arbitrary points on the circumference of the particle.

However, for a rod-shaped particle, the length of its short axis is regarded as the particle size. The term “rod-shaped particle” used herein refers to a particle observed in a TEM image to have a short axis and a long axis perpendicular to the short axis, in which a ratio of the length of the long axis with respect to the length of the short axis is higher than 1.2. In a TEM image, a rod-shaped particle is observed to have, for example, a quadrangular shape such as a rectangular shape, an elliptical shape, or a polygonal shape. The shape of a cross-section that is a plane perpendicular to the long axis of the rod shape may be, for example, circular, elliptical, or polygonal. Specifically, for a rod-shaped particle having an elliptical shape, the length of the long axis means the length of the longest line segment among those line segments connecting any two points on the circumference of the particle and, for a rod-shaped particle having a rectangular or polygonal shape, the length of the long axis means the length of the longest line segment among those line segments that are parallel to the longest side among all sides defining the circumference of the particle and connect any two points on the circumference of the particle. The length of the short axis means the length of the longest line segment that is perpendicular to the line segment defining the length of the long axis, among those line segments connecting any two points on the circumference of the particle.

The average particle size of the semiconductor nanoparticles is determined by measuring the particle size for all measurable particles observed in a TEM image captured at a magnification of from ×50,000 to ×150,000, and calculating the arithmetic mean of the thus measured values. The “measurable” particles are those particles whose outlines are entirely observable in a TEM image. Accordingly, in a TEM image, a particle whose outline is partially not included in the captured area and thus a part of which particle appears to be “cut off” is not a measurable particle. When a single TEM image contains 100 or more measurable particles, the average particle size is determined using this TEM image. Meanwhile, when a single TEM image contains less than 100 measurable particles, another TEM image is captured at a different position, and the particle size is measured for 100 or more measurable particles contained in two or more TEM images to determine the average particle size.

In the semiconductor nanoparticles, the parts composed of the first semiconductor may be in a particulate form and have an average particle size of, for example, 10 nm or smaller, particularly 8 nm or smaller, or smaller than 7.5 nm. The average particle size of the first semiconductor may be in a range of from 1.5 nm to 10 nm, preferably in a range of 1.5 nm or larger but smaller than 8 nm, or 1.5 nm or larger but smaller than 7.5 nm. When the average particle size of the first semiconductor is equal to or smaller than the above-described upper limit value, a quantum size effect is likely to be obtained.

In the semiconductor nanoparticles, the parts composed of the second semiconductor may have a thickness in a range of from 0.1 nm to 50 nm or from 0.1 nm to 10 nm, particularly in a range of from 0.3 nm to 3 nm. When the thickness of the second semiconductor is equal to or larger than the above-described lower limit value, the effect provided by covering the first semiconductor with the second semiconductor is sufficiently exerted, so that band-edge emission is likely to be obtained.

The average particle size of the first semiconductor and the thickness of the second semiconductor may be determined by, for example, observing the semiconductor nanoparticles by HAADF-STEM. Particularly, when the second semiconductor is amorphous, the thickness of the second semiconductor easily observable by HAADF-STEM as a part different from the first semiconductor may be easily determined. In this case, the particle size of the first semiconductor may be determined in accordance with the method described above for semiconductor nanoparticles. When the thickness of the second semiconductor is not uniform, the smallest thickness is defined as the thickness of the second semiconductor in the particles of interest.

Alternatively, the average particle size of the first semiconductor may be measured in advance before covering the first semiconductor with the second semiconductor. The average particle size of the semiconductor nanoparticles is then measured, and the thickness of the second semiconductor may be determined by calculating the difference between the thus measured average particle size and the average particle size of the first semiconductor that has been measured in advance.

The semiconductor nanoparticles preferably have a substantially tetragonal crystal structure. The crystal structure is identified by, for example, measuring the X-ray diffraction (XRD) pattern obtained by XRD analysis in the same manner as described above. The term “substantially tetragonal crystal” used herein indicates that a ratio of the height of a peak at about 48°, which represents hexagonal and orthorhombic crystals, with respect to a main peak at about 26°, which represents a tetragonal crystal, is, for example, 10% or less, or 5% or less.

The semiconductor nanoparticles, when irradiated with a light having a wavelength in a range of from 350 nm to 500 nm, exhibit band-edge emission having an emission peak wavelength on the longer wavelength side than the irradiated light. In the emission spectrum of the semiconductor nanoparticles, the full width at half maximum may be, for example, 45 nm or less, preferably 40 nm or less, or 35 nm or less. A lower limit of the full width at half maximum may be, for example, 15 nm or more. Further, the emission lifetime of a main component (band-edge emission) is preferably 200 ns or shorter.

The term “emission lifetime” used herein refers to a lifetime of emission that is measured using a device called fluorescence lifetime measuring device. Specifically, the above-descried “emission lifetime of a main component” may be determined by the following procedure. First, the semiconductor nanoparticles are allowed to emit light by irradiation with an excitation light, and a change in the attenuation (afterglow) over time is measured for a light having a wavelength near the spectral emission peak, for example, a wavelength within a range of (peak wavelength±50 nm). The measurement of the change over time is initiated upon termination of the irradiation of the excitation light. The resulting attenuation curve is generally a sum of plural attenuation curves derived from relaxation processes of emission, heat, and the like. Accordingly, in the present embodiment, assuming that the attenuation curve contains three components (i.e. three attenuation curves), parameter fitting is performed such that the attenuation curve is represented by the following formula where I(t) denotes the emission intensity. The parameter fitting is performed using a special software.

$$I ( t ) = {A}_{1} exp ( - t / {τ}_{1} ) + {A}_{2} exp ( - t / {τ}_{2} ) + {A}_{3} exp ( - t / {τ}_{3} )$$

In the above formula, τ₁, τ₂, and τ₃ of the respective components each denote the time required for attenuation of the emission intensity to an initial value of 1/e (36.8%), which corresponds to the emission lifetime of each component. The emission lifetime is in ascending order of τ₁, τ₂, and τ₃. Further, A₁, A₂, and A₃ denote contribution ratios of the respective components. For example, when a component having the largest integral value of curves represented by Aₓexp(−t/τₓ) is defined as the main component, the main component has an emission lifetime T of 200 ns or shorter. Such emission is presumed to be band-edge emission. For identification of the main component, the values of Aₓ×τₓ obtained by integration of the t value of Aₓexp(−t/τₓ) from 0 to infinity are compared, and a component having the largest value is defined as the main component.

It is noted here that an actual attenuation curve is not much different from those attenuation curves that are each drawn from a formula obtained by performing parameter fitting where the emission attenuation curve is assumed to contain three, four, or five components. Therefore, for determination of the emission lifetime of the main component in the present embodiment, the number of components contained in the emission attenuation curve is assumed to be three so as to avoid complicated parameter fitting.

The emission of the semiconductor nanoparticles may include defect emission (e.g., donor-acceptor emission) in addition to band-edge emission; however, the emission is preferably substantially band-edge emission alone. Defect emission generally has a longer emission lifetime and a broader spectrum with a peak on the longer wavelength side as compared to band-edge emission. The expression “substantially band-edge emission alone” used herein means that the purity of the band-edge emission component in the emission spectrum (hereinafter, also referred to as “band-edge emission purity”) is 40% or higher, and this purity is preferably 70% or higher, more preferably 80% or higher, still more preferably 90% or higher, particularly preferably 95% or higher. An upper limit value of the purity of the band-edge emission component may be, for example, 100% or lower, lower than 100%, or 99% or lower. The “purity of the band-edge emission component” is represented by the following formula when parameter fitting, where a band-edge emission peak and a defect emission peak are assumed to each have a shape of normal distribution, is performed for the emission spectrum to separate its peaks into two types, which are the band-edge emission peak and the defect emission peak, and the areas of these peaks are denoted as a₁ and a₂, respectively:

$$Purity ( \% ) of band - edge emission component = {a}_{1} / ( {a}_{1} + {a}_{2} ) \times 100.$$

When the emission spectrum contains no band-edge emission at all, i.e. when the emission spectrum contains only defect emission, the purity of the band-edge emission component is 0%; when the emission spectrum contains band-edge emission and defect emission that have the same peak area, the purity of the band-edge emission component is 50%; and when the emission spectrum contains only band-edge emission, the purity of the band-edge emission component is 100%.

The internal quantum yield of the band-edge emission is defined as a value obtained by multiplying the internal quantum yield, which is measured using a quantum yield measuring device at a temperature of 25° C. and calculated under the conditions of an excitation light wavelength of 450 nm and a fluorescence wavelength range of from 470 nm to 900 nm, an excitation light wavelength of 365 nm and a fluorescence wavelength range of from 450 nm to 950 nm, or an excitation light wavelength of from 450 nm and a fluorescence wavelength range of from 500 nm to 950 nm, by the above-described purity of the band-edge emission component, and dividing the product by 100. The quantum yield of the band-edge emission of the semiconductor nanoparticles is, for example, 15% or more, preferably 50% or more, more preferably 60% or more, still more preferably 70% or more, particularly preferably 80% or more.

The peak position of the band-edge emission by the semiconductor nanoparticles may be shifted by modifying the particle size of the semiconductor nanoparticles. For example, when the particle size of the semiconductor nanoparticles is reduced, the peak wavelength of the band-edge emission tends to shift to the shorter wavelength side. A further reduction in the particle size of the semiconductor nanoparticles tends to further reduce the spectral full width at half maximum of the band-edge emission.

When the semiconductor nanoparticles exhibit defect emission in addition to band-edge emission, the intensity ratio of the band-edge emission, which is determined as a ratio of the maximum peak intensity of the band-edge emission with respect to the maximum peak intensity of the defect emission, may be, for example, 0.75 or higher, and it is preferably 0.85 or higher, more preferably 0.9 or higher, particularly preferably 0.93 or higher. An upper limit value thereof may be, for example, 1 or lower, lower than 1, or 0.99 or lower. The intensity ratio of the band-edge emission is represented by the following formula when parameter fitting, where a band-edge emission peak and a defect emission peak are assumed to each have a shape of normal distribution, is performed for the emission spectrum to separate its peaks into two types, which are the band-edge emission peak and the defect emission peak, and the maximum intensities of these peaks are denoted as b₁ and b₂, respectively:

$$Intensity ratio of band - edge emission = {b}_{1} / ( {b}_{1} + {b}_{2} ) .$$

When the emission spectrum contains no band-edge emission at all, i.e. when the emission spectrum contains only defect emission, the intensity ratio of the band-edge emission is 0; when the emission spectrum contains band-edge emission and defect emission that have the same maximum peak intensity, the intensity ratio of the band-edge emission is 0.5; and when the emission spectrum contains only band-edge emission, the intensity ratio of the band-edge emission is 1.

The semiconductor nanoparticles preferably also exhibit an absorption or excitation spectrum (also referred to as “fluorescence excitation spectrum”) with an exciton peak. An exciton peak is a peak resulting from exciton formation, and the appearance of this peak in an absorption or excitation spectrum means that the particles have a small particle size distribution and few crystal defects, and are thus suitable for band-edge emission. A sharper exciton peak means that an aggregate of the semiconductor nanoparticles contains a greater amount of particles having a uniform particle size with few crystal defects. Accordingly, it is expected that the semiconductor nanoparticles exhibit emission with a narrower full width at half maximum and an improved emission efficiency. In the absorption or excitation spectrum of the semiconductor nanoparticles of the present embodiment, an exciton peak is observed, for example, in a range of from 350 nm to 1,000 nm, preferably from 450 nm to 590 nm. The excitation spectrum for checking the presence or absence of an exciton peak may be measured by setting the observation wavelength around the peak wavelength.

The semiconductor nanoparticles containing In and Ga in the composition of the first semiconductor emit a light having an emission peak wavelength in a range of from 490 nm to 545 nm when irradiated with a light having a peak at about 450 nm. The emission peak wavelength is preferably from 495 nm to 540 nm. In the emission spectrum, the full width at half maximum of the emission peak is, for example, 70 nm or less, preferably 60 nm or less, more preferably 50 nm or less, particularly preferably 40 nm or less. A lower limit value of the full width at half maximum may be, for example, not less than 10 nm. For example, when the composition of the first semiconductor is Ag—In—Ga—S that is obtained by substituting In, which is a Group 13 element, in Ag—In—S at least partially with Ga which is also a Group 13 element, the emission peak shifts to the shorter wavelength side.

The surfaces of the semiconductor nanoparticles may be modified with a surface modifier. Specific examples of the surface modifier include an amino alcohol having from 2 to 20 carbon atoms, an ionic surface modifier, a nonionic surface modifier, a nitrogen-containing compound containing a hydrocarbon group having from 4 to 20 carbon atoms, a sulfur-containing compound containing a hydrocarbon group having from 4 to 20 carbon atoms, an oxygen-containing compound containing a hydrocarbon group having from 4 to 20 carbon atoms, a phosphorus-containing compound containing a hydrocarbon group having from 4 to 20 carbon atoms, and a halide of a Group 2, 12, or 13 element. These surface modifiers may be used singly, or in combination of two or more different kinds thereof. The details of the above-exemplified surface modifiers are as described above.

The surfaces of the semiconductor nanoparticles may also be modified with a halide of a Group 13 element. By modifying the surfaces of the semiconductor nanoparticles with a halide of a Group 13 element, the internal quantum yield of the band-edge emission is improved. This halide of a Group 13 element is as described above.

The emission of the semiconductor nanoparticles surface-modified with a halide of a Group 13 element may include defect emission (donor-acceptor emission) in addition to band-edge emission; however, the emission is preferably substantially band-edge emission alone. The expression “substantially band-edge emission alone” used herein means that, as described for the above-described semiconductor nanoparticles, the purity of the band-edge emission component is preferably 70% or higher, more preferably 80% or higher, still more preferably 90% or higher, particularly preferably 95% or higher. An upper limit value of the purity of the band-edge emission component may be, for example, 100% or lower, lower than 100%, or 99% or lower.

The measurement of the quantum yield of the band-edge emission of the semiconductor nanoparticles surface-modified with a halide of a Group 13 element is as described for the above-described semiconductor nanoparticles, and the quantum yield of the band-edge emission is, for example, 15% or more, preferably 50% or more, more preferably 60% or more, still more preferably 70% or more, particularly preferably 80% or more.

### Light Emitting Device

The light emitting device includes: a light conversion member containing the above-described semiconductor nanoparticles; and a semiconductor light emitting element. According to this light emitting device, for example, the semiconductor nanoparticles absorb a portion of the light irradiated from the semiconductor light emitting element and emit a long-wavelength light. Further, the light emitted from the semiconductor nanoparticles is combined with the remainder of the light irradiated from the semiconductor light emitting element, and the resulting mixed light may be utilized as a light emitted from the light emitting device.

Specifically, by using a semiconductor light emitting element that emits blue-violet light or blue light having a peak wavelength of about from 400 nm to 490 nm as the above-described semiconductor light emitting element and semiconductor nanoparticles that absorb blue light and emit yellow light as the above-described semiconductor nanoparticles, a light emitting device that emits white light may be obtained. A white light emitting device may also be obtained by using, as the above-described semiconductor nanoparticles, two kinds of semiconductor nanoparticles, which are those that absorb blue light and emit green light and those that absorb blue light and emit red light.

Alternatively, a white light emitting device may be obtained even in the case of using a semiconductor light emitting element that emits ultraviolet rays having a peak wavelength of 400 nm or shorter and three kinds of semiconductor nanoparticles that each absorb ultraviolet rays and emit blue light, green light, or red light. In this case, it is desired that all of the light emitted from the light emitting element be absorbed and converted by the semiconductor nanoparticles so that the ultraviolet rays emitted from the light emitting element do not leak to the outside.

Further, a white light emitting device may be obtained by using a semiconductor light emitting element that emits blue-green light having a peak wavelength of about from 490 nm to 510 nm and semiconductor nanoparticles that absorb the blue-green light and emit red light.

Moreover, it is possible to obtain a light emitting device that emits near-infrared rays by using a semiconductor light emitting element that emits visible light, for example, one which emits red light having a wavelength of from 700 nm to 780 nm, as the above-described semiconductor light emitting element, and semiconductor nanoparticles that absorb visible light and emit near-infrared rays as the above-described semiconductor nanoparticles.

The semiconductor nanoparticles may be used in combination with other semiconductor quantum dots, or any other phosphors that are not quantum dots (e.g., organic phosphors or inorganic phosphors). The other semiconductor quantum dots are, for example, binary semiconductor quantum dots. As the phosphors that are not quantum dots, for example, garnet-based phosphors such as aluminum-garnet phosphors may be used. Examples of the garnet-based phosphors include a cerium-activated yttrium-aluminum-garnet phosphor, and a cerium-activated lutetium-aluminum-garnet phosphor. Examples of phosphors that may be used also include: nitrogen-containing calcium aluminosilicate-based phosphors activated by europium and/or chromium; silicate-based phosphors activated by europium; β-SiAlON-based phosphors; nitride-based phosphors, such as CASN-based or SCASN-based phosphors; rare earth nitride-based phosphors, such as LnSi₃N₁₁-based or LnSiAlON-based phosphors; oxynitride-based phosphors, such as BaSi₂O₂N₂:Eu-based or Ba₃Si₆O₁₂N₂:Eu-based phosphors; sulfide-based phosphors, such as CaS-based, SrGa₂S₄-based, or ZnS-based phosphors; chlorosilicate-based phosphors; SrLiAl₃N₄:Eu phosphor; SrMg₃SiN₄:Eu phosphor; and manganese-activated fluoride complex phosphors, such as a K₂SiF₆:Mn phosphor.

In the light emitting device, the light conversion member containing the semiconductor nanoparticles may be, for example, a sheet or a plate-like member, or may be a member having a three-dimensional shape. One example of the member having a three-dimensional shape is, in a surface-mount light-emitting diode in which a semiconductor light emitting element is arranged on the bottom surface of a recess formed in a package, a sealing member that is formed by filling the recess with a resin to seal the light emitting element.

Another example of the light conversion member is, in a case where a semiconductor light emitting element is arranged on a planar substrate, a resin member that is formed in such a manner to surround the upper surface and side surfaces of the semiconductor light emitting element with a substantially uniform thickness. Yet another example of the light conversion member is, in a case where the surrounding of a semiconductor light emitting element is filled with a reflective material-containing resin member such that the upper end of this resin member forms a single plane with the semiconductor light emitting element, a resin member that is formed in a plate-like shape with a prescribed thickness on top of the semiconductor light emitting element and the reflective material-containing resin member.

The light conversion member may be in contact with the semiconductor light emitting element, or may be arranged apart from the semiconductor light emitting element. Specifically, the light conversion member may be a pellet-like, sheet-like, plate-like, or rod-like member arranged apart from the semiconductor light emitting element, or a member arranged in contact with the semiconductor light emitting element, such as a sealing member, a coating member (a member covering the light emitting element that is arranged separately from a molded member), or a molded member (e.g., a lens-shaped member).

In the light emitting device, when two or more kinds of semiconductor nanoparticles that emit different wavelengths of light are used, the two or more kinds of semiconductor nanoparticles may be mixed within a single light conversion member, or two or more light conversion members each containing only a single kind of semiconductor nanoparticles may be used in combination. In the latter case, the two or more light conversion members may form a laminated structure, or may be arranged in a dot-like or striped pattern on a plane.

One example of the semiconductor light emitting element is an LED chip. The LED chip may include a semiconductor layer composed of one or more selected from the group consisting of GaN, GaAs, InGaN, AlInGaP, GaP, SiC, and ZnO. A semiconductor light emitting element that emits blue-violet light, blue light, or ultraviolet rays includes a semiconductor layer composed of, for example, a GaN compound having a composition represented by InₓAl_{y}Ga_{1-x-y}N, wherein, 0≤X, 0≤Y, X+Y<1.

The light emitting device of the present embodiment is preferably incorporated as a light source in a liquid-crystal display device. Because the band-edge emission by the semiconductor nanoparticles has a short emission lifetime, a light emitting device using the semiconductor nanoparticles is suitable as a light source of a liquid-crystal display device that requires a relatively high response speed. Further, the semiconductor nanoparticles of the present embodiment may exhibit band-edge emission having an emission peak with a small full width at half maximum. Therefore, a liquid-crystal display device having good color reproducibility may be obtained without the use of a thick color filter by configuring the light emitting device such that: blue light having a peak wavelength in a range of from 420 nm to 490 nm is provided by a blue semiconductor light emitting element, while green light having a peak wavelength in a range of from 510 nm to 550 nm, preferably from 530 nm to 540 nm, and red light having a peak wavelength in a range of from 600 nm to 680 nm, preferably from 630 nm to 650 nm, are provided by the semiconductor nanoparticles; or ultraviolet light having a peak wavelength of 400 nm or shorter is provided by a semiconductor light emitting element, while blue light having a peak wavelength in a range of from 430 nm to 470 nm, preferably from 440 nm to 460 nm, green light having a peak wavelength in a range of from 510 nm to 550 nm, preferably from 530 nm to 540 nm, and red light having a peak wavelength in a range of from 600 nm to 680 nm, preferably from 630 nm to 650 nm, are provided by the semiconductor nanoparticles. The light emitting device may be used as, for example, a direct backlight or an edge backlight.

Alternatively, a sheet, a plate-like member, or a rod, which contains the semiconductor nanoparticles and is made of a resin or glass, may be incorporated into a liquid-crystal display device as a light conversion member independent of the light emitting device.

### EXAMPLES

The present invention will now be described more concretely by way of Examples; however, the present invention is not limited to the below-described Examples.

### Example 1

### First Step

A first mixture was obtained by mixing 0.54 mmol of silver ethyl xanthate (Ag(EX)), 0.65 mmol of indium acetate (In(OAc)₃), 1.08 mmol of gallium ethyl xanthate (Ga(EX)₃), and 45 mL of oleylamine (OLA). This first mixture was subjected to a first heat treatment performed at 170° C. for 30 minutes with stirring in a nitrogen atmosphere. After this heat treatment, the thus obtained suspension was allowed to cool and then centrifuged (radius: 146 mm, at 3,800 rpm for 5 minutes), and the resulting precipitate was removed to obtain a dispersion of first semiconductor nanoparticles.

### Second Step

A second mixture was obtained by mixing 10 mL of the above-obtained dispersion containing 0.02 mmol-equivalent of the first semiconductor nanoparticles in terms of nanoparticle concentration, 0.07 mmol of gallium acetylacetonate (Ga(acac)₃), 0.07 mmol of 1,3-dimethylthiourea, 3.5 mL of chloroform, and 12 mL of oleylamine. The pressure was reduced while stirring this second mixture, and the temperature was raised to 80° C. to perform a heat treatment at 80° C. for 10 minutes with the reduced pressure being maintained, thereby removing the added chloroform. Thereafter, the temperature was further raised to 260° C. in a nitrogen atmosphere to perform a second heat treatment for 120 minutes. After this heat treatment, the thus obtained suspension was allowed to cool and then centrifuged (radius: 146 mm, at 3,800 rpm for 5 minutes), and the resulting precipitate was removed to obtain a dispersion of second semiconductor nanoparticles.

### Third Step

Subsequently, 10 mL of the above-obtained dispersion containing 0.02 mmol-equivalent of the second semiconductor nanoparticles in terms of nanoparticle concentration was mixed with 0.07 mmol of gallium chloride (GaCl₃) to obtain a third mixture. The pressure was reduced while stirring this third mixture, and the temperature was raised to 80° C. to perform a heat treatment at 80° C. for 10 minutes with the reduced pressure being maintained. Thereafter, the temperature was further raised to 280° C. in a nitrogen atmosphere to perform a third heat treatment for 60 minutes. After this heat treatment, the thus obtained suspension was allowed to cool and then centrifuged (radius: 146 mm, at 3,800 rpm for 5 minutes), and the resulting precipitate was removed, whereby a dispersion of semiconductor nanoparticles of Example 1 was obtained as a dispersion of third semiconductor nanoparticles.

### Reference Example 1

A dispersion of first semiconductor nanoparticles was obtained in the same manner as in Example 1. This dispersion was used as a dispersion of semiconductor nanoparticles of Reference Example 1.

### Comparative Example 1

A dispersion of second semiconductor nanoparticles was obtained in the same manner as in Example 1. This dispersion was used as a dispersion of semiconductor nanoparticles of Comparative Example 1.

### Comparative Example 2

A dispersion of first semiconductor nanoparticles was obtained in the same manner as in Example 1. Subsequently, 0.07 mmol of gallium chloride (GaCl₃) was added to and dispersed in the thus obtained dispersion of the first semiconductor nanoparticles. The pressure was reduced while stirring this dispersion, and the temperature was raised to 80° C. to perform a heat treatment at 80° C. for 10 minutes with the reduced pressure being maintained. Thereafter, the temperature was further raised to 280° C. in a nitrogen atmosphere to perform a heat treatment for 60 minutes. After this heat treatment, the thus obtained suspension was allowed to cool and then centrifuged (radius: 146 mm, at 3,800 rpm for 5 minutes), and the resulting precipitate was removed to obtain a dispersion of semiconductor nanoparticles of Comparative Example 2.

### Comparative Example 3

A dispersion of semiconductor nanoparticles of Comparative Example 3 was obtained in the same manner as in Example 1, except that magnesium chloride (MgCl₃) was used in place of gallium chloride in the production of the third semiconductor nanoparticles.

### Comparative Example 4

A dispersion of semiconductor nanoparticles of Comparative Example 4 was obtained in the same manner as in Example 1, except that zinc chloride (ZnCl₃) was used in place of gallium chloride in the production of the third semiconductor nanoparticles.

### Absorption and Emission Characteristics

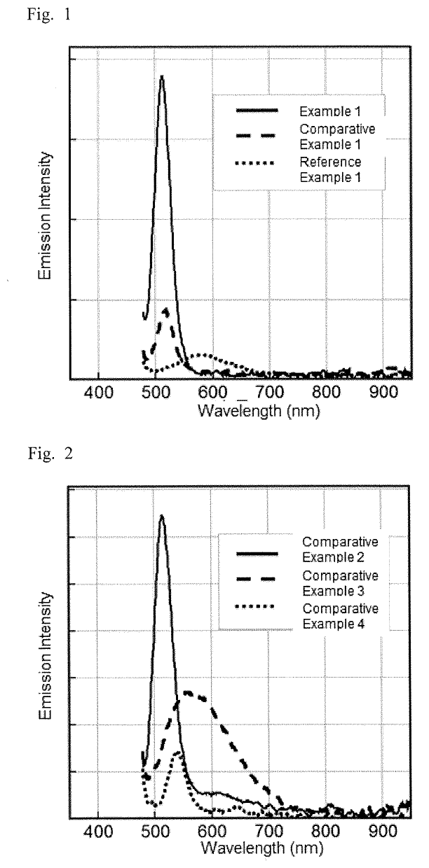

For each of the semiconductor nanoparticles obtained in Example 1, Reference Example 1, and Comparative Examples 1 to 4, emission spectrum was measured, and the band-edge emission peak wavelength, the band-edge emission purity, the internal quantum yield, and the full width at half maximum were determined. It is noted here that the emission spectrum was measured in a wavelength range of 300 nm to 950 nm using a quantum efficiency measurement system (trade name: QE-2100, manufactured by Otsuka Electronics Co., Ltd.) at room temperature (25° C.) with an excitation light wavelength of 365 nm, and the internal quantum yield was calculated for a wavelength range of 450 nm to 950 nm. The results of the measurement are shown in Table 1. Further, the emission spectra of the semiconductor nanoparticles of Example 1, Comparative Example 1, and Reference Example 1 are shown in FIG. 1, and the emission spectra of the semiconductor nanoparticles of Comparative Examples 2, 3, and 4 are shown in FIG. 2. FIG. 1 shows relative emission intensity spectra normalized by the maximum emission intensity of the semiconductor nanoparticles of Example 1, and FIG. 2 shows relative emission intensity spectra normalized by the maximum emission intensity of the semiconductor nanoparticles of Comparative Example 2.

TABLE 1

| | Peak | Full width | Band-edge | Internal |
|---|---|---|---|---|
| | emission | at half | emission | quantum |
| | wavelength | maximum | purity | yield |
| | (nm) | (nm) | (%) | (%) |
| Example 1 | 514 | 35 | 100 | 70 |
| Reference | 580 | 113 | 10 | 20 |
| Example 1 | | | | |
| Comparative | 519 | 36 | 100 | 15 |
| Example 1 | | | | |
| Comparative | 517 | 40 | 91 | 34 |
| Example 2 | | | | |
| Comparative | 542 | 37 | 37 | 7 |
| Example 3 | | | | |
| Comparative | 570 | 137 | 2 | 42 |
| Example 4 | | | | |

The semiconductor nanoparticles of Example 1 exhibited band-edge emission with excellent band-edge emission purity and excellent internal quantum yield.

### Example 2

### First Step

A first mixture was obtained by mixing 0.3 mmol of copper (I) ethyl xanthate (Cu(EX)), 1.2 mmol of silver ethyl xanthate (Ag(EX)), 1.5 mmol of indium acetate (In(OAc)₃), and 60 mL of oleylamine (OLA). This first mixture was heat-treated at 140° C. for 60 minutes with stirring in a nitrogen atmosphere. The thus obtained suspension was allowed to cool and then centrifuged (radius: 146 mm, at 2,800 rpm for 5 minutes), and the resulting precipitate was removed to obtain a dispersion of first semiconductor nanoparticles.

### Second Step

A second mixture was obtained by mixing 20 mL of the dispersion containing 1.0 mmol-equivalent of the first semiconductor nanoparticles in terms of nanoparticle concentration, which was obtained in the first step, with 1.0 mmol of gallium acetylacetonate (Ga(acac)₃), 1.5 mmol of 1,3-dimethylthiourea, and 0.75 ml of an oleylamine solution containing 0.075 mmol of gallium chloride (GaCl₃). This second mixture was heat-treated at 270° C. for 60 minutes with stirring in a nitrogen atmosphere. Thereafter, the thus obtained suspension was allowed to cool, whereby a dispersion of second semiconductor nanoparticles was obtained.

### Third Step

A third mixture was obtained by mixing 10 mL of the dispersion containing 0.25 mmol-equivalent of the second semiconductor nanoparticles in terms of nanoparticle concentration, which was obtained in the second step, with 7.5 mL of oleylamine containing 0.75 mmol of gallium chloride (GaCl₃). This third mixture was heat-treated at 270° C. for 120 minutes with stirring in a nitrogen atmosphere. Thereafter, the thus obtained suspension was allowed to cool, whereby a dispersion of third semiconductor nanoparticles was obtained.

### Comparative Example 5

### First Step

A first mixture was obtained by mixing 0.3 mmol of copper (I) ethyl xanthate (Cu(EX)), 1.2 mmol of silver ethyl xanthate (Ag(EX)), 1.5 mmol of indium acetate (In(OAc)₃), and 60 mL of oleylamine (OLA). This first mixture was heat-treated at 140° C. for 60 minutes with stirring in a nitrogen atmosphere. The thus obtained suspension was allowed to cool and then centrifuged (radius: 146 mm, at 2,800 rpm for 5 minutes), and the resulting precipitate was removed to obtain a dispersion of first semiconductor nanoparticles.

### Comparative Example 6

### Second Step

A second mixture was obtained by mixing 20 mL of the dispersion containing 1.0 mmol-equivalent of the first semiconductor nanoparticles in terms of nanoparticle concentration, which was obtained in Comparative Example 5, with 19.23 ml of an oleylamine solution containing 1.0 mmol of gallium ethyl xanthate (Ga(EX)₃) and 0.75 ml of an oleylamine solution containing 0.075 mmol of gallium chloride (GaCl₃). This second mixture was heat-treated at 270° C. for 60 minutes with stirring in a nitrogen atmosphere. Thereafter, the thus obtained suspension was allowed to cool, whereby a dispersion of second semiconductor nanoparticles was obtained.

### Measurement of Emission Spectrum

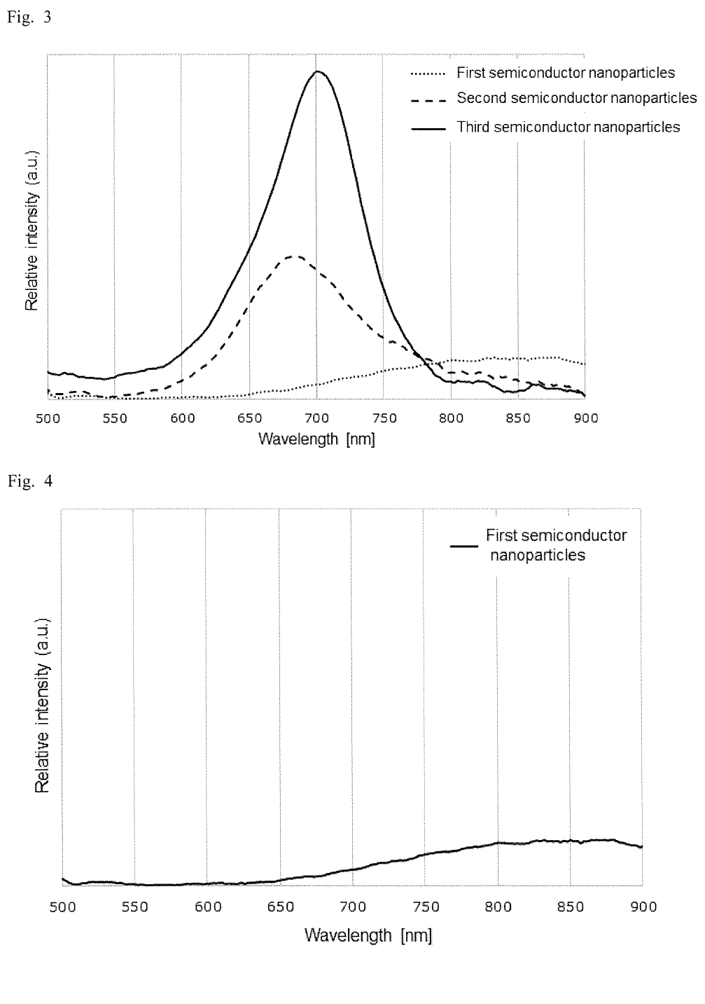

For each of the first, second, and third semiconductor nanoparticles obtained in Example 2 and the first semiconductor nanoparticles obtained in Comparative Example 5, emission spectrum was measured, and the band-edge emission peak wavelength, the full width at half maximum, the band-edge emission purity, and the internal quantum yield of the band-edge emission were determined. It is noted here that the emission spectrum was measured in a wavelength range of 300 nm to 900 nm using a quantum efficiency measurement system (trade name: QE-2100, manufactured by Otsuka Electronics Co., Ltd.) at room temperature (25° C.) with an excitation light wavelength of 450 nm, and the internal quantum yield was calculated for a wavelength range of 500 nm to 900 nm. The results thereof are shown in Table 2 and FIGS. 3 and 4. FIG. 3 shows relative emission intensity spectra normalized by the maximum emission intensity of the third semiconductor nanoparticles of Example 2. It is noted here that emission spectrum was not measured for the second semiconductor nanoparticles obtained in Comparative Example 6 because emission was not confirmed.

TABLE 2

| | | Peak | Full width | Band-edge | Internal |
|---|---|---|---|---|---|
| | | emission | at half | emission | quantum |
| | | wavelength | maximum | purity | yield |
| | | (nm) | (nm) | (%) | (%) |
| Example 2 | First semiconductor | 986 | 163 | 43.1 | 8.9 |
| | nanoparticles | | | | |
| | Second semiconductor | 678 | 100 | 51.8 | 22.9 |
| | nanoparticles | | | | |
| | Third semiconductor | 703 | 84 | 100.0 | 47.1 |
| | nanoparticles | | | | |
| Comparative | First semiconductor | 986 | 163 | 43.1 | 8.9 |
| Example 5 | nanoparticles | | | | |

The semiconductor nanoparticles of Example 2 exhibited band-edge emission with excellent band-edge emission purity and excellent internal quantum yield.

The disclosure of Japanese Patent Application No. 2021-066682 (filing date: Apr. 9, 2021) is hereby incorporated by reference in its entirety. All the documents, patent applications, and technical standards that are described in the present specification are hereby incorporated by reference to the same extent as if each individual document, patent application, or technical standard is concretely and individually described to be incorporated by reference.

What is claimed is:

1. A method of producing semiconductor nanoparticles, the method comprising:
providing first semiconductor nanoparticles that comprise a semiconductor comprising an element M¹, an element M², and an element Z, and in which the element M¹ is at least one element selected from the group consisting of Ag, Cu, Au, and alkali metals, and contains at least Ag, the element M² is at least one element selected from the group consisting of Al, Ga, In, and Tl, and contains at least one of In or Ga, and the element Z comprises at least one element selected from the group consisting of S, Se, and Te;
performing a heat treatment of a mixture which comprises the first semiconductor nanoparticles, a compound comprising a Group 13 element, and a compound comprising a Group 16 element, to obtain second semiconductor nanoparticles; and
performing a heat treatment of the second semiconductor nanoparticles in the presence of a halide of a Group 13 element to obtain third semiconductor nanoparticles.

2. The method according to claim 1, wherein the halide of a Group 13 element comprises a chloride.

3. The method according to claim 1, wherein the temperature at which the heat treatment of the second semiconductor nanoparticles is performed in the presence of the halide of the Group 13 element is 200° C. or higher and 320° C. or lower.

4. The method according to claim 1, wherein the halide of the Group 13 element is present in an amount of 0.01 or more and 50 or less in terms of a molar ratio of the halide of a Group 13 element with respect to the second semiconductor nanoparticles.

5. The method according to claim 2, wherein the temperature at which the heat treatment of the second semiconductor nanoparticles is performed in the presence of the halide of the Group 13 element is 200° C. or higher and 320° C. or lower.

6. The method according to claim 2, wherein the halide of the Group 13 element is present in an amount of 0.01 or more and 50 or less in terms of a molar ratio of the halide of a Group 13 element with respect to the second semiconductor nanoparticles.

7. The method according to claim 3, wherein the halide of the Group 13 element is present in an amount of 0.01 or more and 50 or less in terms of a molar ratio of the halide of a Group 13 element with respect to the second semiconductor nanoparticles.

8. The method according to claim 5, wherein the halide of the Group 13 element is present in an amount of 0.01 or more and 50 or less in terms of a molar ratio of the halide of a Group 13 element with respect to the second semiconductor nanoparticles.
